(19) United States
(12) Patent Application Publication
(10) Pub. No.: US 2016/0104355 A1
(43) Pub. Date: Apr. 14, 2016

(54) WEARABLE ARTICLES INCLUDING COMMUNICATIONS AND ALERT FEATURES

(71) Applicant: Smart Siren Technology, Inc., New York, NY (US)

(72) Inventors: Katharyn Maris Alexander, New York, NY (US); Howard Alexander, New York, NY (US)

(21) Appl. No.: 14/879,935

(22) Filed: Oct. 9, 2015

Related U.S. Application Data
(60) Provisional application No. 62/062,449, filed on Oct. 10, 2014.

(51) Int. Cl. G08B 3/10

(52) U.S. Cl. CPC G08B 3/10

(57) ABSTRACT

The disclosure provides alarm module devices such as a wearable article including a base portion and an upper portion covering the base portion, wherein the base portion and the upper portion cooperating to define a compartment. The device can further include at least one acoustical transducer, and a printed circuit board (or other suitable activation circuitry) disposed in the compartment including circuitry for actuating the at least one acoustical transducer. The device can further include a power source in selective electrical communication with the at least one acoustical transducer by way of the printed circuit board.

### CROSS-REFERENCE TO RELATION APPLICATIONS

This patent application claims priority to U.S. Provisional Application No. 62/062,449 filed Oct. 10, 2014, the disclosure and teachings of which are incorporated by reference herein. This patent application is also related to U.S. patent application Ser. No. 13/622,813, filed Sep. 19, 2012, which in turn claims the benefit of priority to U.S. Provisional Patent Application Ser. No. 61/657,412, filed Jun. 8, 2012. Each of the aforementioned patent applications is incorporated by reference herein in its entirety for any purpose whatsoever.

### COPYRIGHT NOTICE

A portion of the disclosure of this patent document contains material that is subject to copyright protection, particularly the Figures appended hereto. The copyright owner has no objection to the reproduction by anyone of the patent document or patent disclosure as it appears in the Patent and Trademark Office, patent file or records, but otherwise reserves all copyrights whatsoever.

### BACKGROUND

1. Field

The present disclosure is generally directed to wearable articles that can contain electronic components. More particularly, the present disclosure is directed to alarm modules that can be integrated into various embodiments of wearable articles, such as jewelry and the like that may include one or more of an acoustic alarm, a geolocation device, a communication device, and a lighting device, among others.

2. Description of Related Art

Many devices have been constructed to provide a wearer with an ability to sound an alarm, such as certain remote electronic keys sold with automobiles, among other things. However, Applicant has come to appreciate that there are certain gaps in the art and that there are needs for providing improved devices that can sound an alarm. The present disclosure solves these and other problems.

### SUMMARY

The purpose and advantages of the present disclosure will be set forth in, and be apparent from, the description that follows, as well as will be learned by practice of embodiments made in accordance with the disclosure. Additional advantages of the invention will be realized and attained by the methods and systems particularly pointed out in the written description and claims hereof, as well as from the appended drawings.

To achieve these and other advantages and in accordance with the purposes of the disclosure, as embodied and broadly described, in accordance with some implementations, the disclosure provides an alarm module device that can be integrated into a variety of articles, such as an article of jewelry or other wearable article or accessory. The device can include a base portion and an upper portion covering the base portion, wherein the base portion and the upper portion cooperating to define a compartment. The device can further include at least one acoustical transducer, and a printed circuit board (or other suitable circuitry) mounted in the compartment including circuitry for actuating the at least one acoustical transducer. The device can further include a power source in selective electrical communication with the at least one acoustical transducer by way of the printed circuit board, and an intelligent power conversion circuit which can emit a higher drive voltage.

In further accordance with the disclosure, the base portion can define a first cavity therein, and/or the upper portion can define a second cavity therein. The first and/or second cavity can cooperate to define the compartment. In various implementations, the acoustical transducer can be disposed wholly or partially inside and/or outside the compartment. For example, the acoustical transducer can be contained within the compartment, or if desired, the acoustical transducer can be disposed on an exterior portion of the alarm module. For example, in some embodiments, the acoustical transducer can be integrated with a faux jewel or other decorative portion of the alarm module when integrated into an article of jewelry.

In accordance with further aspects, the upper (and/or lower) portion of the device can define at least a portion of a resonant chamber. The upper (and/or lower) portion can still further define at least one acoustical passage therethrough to facilitate transmission of acoustical energy generated by the acoustical transducer from inside the resonant chamber to a location outside of the wearable article.

In accordance with a further aspect, the upper portion can be rotatably displaceable with respect to the base portion. If desired, the acoustical transducer can be actuated by rotating the upper portion with respect to the base portion. In other embodiments, the transducer can be actuated by means of a push button, slide switch, or other known means within the scope of the present application.

The alarm module device can be integrated into an article of jewelry, such as a finger ring, a time piece (e.g., wristwatch), a pendant (e.g., clipable or wearable on a chain), a bracelet, and the like. The alarm module device can be attached or attachable to a sport band (e.g., silicone or elastomeric wrist or ankle band), and the like. Preferably, the band is made of neoprene or an elastomer material, and can be provided with a geometric pattern or texture for aesthetic appearance. By providing a band of elastomeric material, the article can be slipped onto wearer, i.e., on the wearer's wrist, without the requirement for a mechanical locking structure or metal casting. Preferably, the width of the article is small, and preferably no more than 30 millimeters wide.

In accordance with still further aspects, the printed circuit board can be disposed within an annularly shaped rotor disposed within the compartment. If desired, the rotor can be connected to or otherwise be in rotatable contact with the upper portion so that the rotor rotates with the upper portion when the upper portion is rotated. In some implementations, the rotor can be disposed within a centering ring. The centering ring can be arranged with respect to the base portion to prevent the centering ring from rotating with respect to the base portion when the rotor rotates with the upper portion. If desired, the rotor can be rotatably displaced with respect to the centering ring from a first rotational position to a second rotational position. In some implementations, the rotational position of the rotor with respect to the centering ring can be maintained in the first and/or second rotational positions by first and second detents. In some embodiments, at least one of the first and second detents can include a circumferential deflection groove formed into the centering ring separating upper and lower ring portions of the centering ring. The detent can be energized by compressing the upper and lower ring portions together into the deflection groove. In some embodiments, the deflection groove can pass all the way through the centering ring from a radially outer surface of the centering ring to a radially inner surface of the centering ring along part or all of the circumferential extent of the deflection groove. At least one of the first and second detents can further include a protrusion formed on at least one of an upper and lower edge of the centering ring. For example, the protrusion can be formed on at least one of the upper and lower ring portions. In operation, the protrusion can snap into a recess formed into the rotor when the rotor is in at least one of the first and second rotational positions. The rotor can be provided with a track for accepting the centering ring including one or more notches for receiving the protrusion(s) of the centering ring. For example, the centering ring can be received in an annular groove formed into an outer radial surface of the rotor. The centering ring can be a split ring having a first circumferential end near a second circumferential end. If desired, the first circumferential end and the second circumferential end can each abut a protrusion formed on the base portion and extending into the compartment, wherein the protrusion prevents the centering ring from rotating with respect to the base portion when the upper portion is rotated with respect to the base portion. In other embodiments, the centering ring can be pinned into the base portion or otherwise prevented from rotating with respect to the base portion.

In some implementations, the centering ring includes a magnetic portion, such as a permanent magnet inserted into and/or onto a portion of the centering ring. In such embodiments, the printed circuit board can include a magnetically activated switch mounted thereon or in electrical communication with the printed circuit board for delivering electrical power from the power source to the circuitry, then the acoustical transducer. The magnetically activated switch can be actuated when the magnetic portion of the centering ring is placed in close proximity with the magnetically activated switch. The magnetically activated switch can be actuated when the rotor is rotatably displaced with respect to the centering ring from the first rotational position to the second rotational position. The magnetically activated switch can include a reed switch or an active magnetic sensor. In alternate embodiments of the invention, other electrical triggers or actuators can replace the magnetically activated switch.

In some implementations, the centering ring includes a dual push-button actuation. Rather than providing a rotational capability between the centering ring and the base portion, the centering ring can be provided with a dual push-button feature which requires simultaneous selection for actuation. The implementations comprising the dual push-button actuation feature can be provided with a magnetic portion, such as a permanent magnet with a magnetically activated switch inserted into and/or onto a portion of the centering ring. The magnetically activated switch can be actuated when the magnetic portion of the centering ring is placed in close proximity with the magnetically activated switch by means of selection and downward placement of the dual push-button actuation component. In other implementations, a single or dual mechanical switch(es) may be used, and monitored by the control circuitry to eliminate false actuation.

The power source can include a power storage device, such as a capacitor or battery, or other suitable source of power. The power source can be located near a bottom of the compartment. A conductive lead can be included that extends from a lower face of the battery around to an upper face of the battery. The conductive lead can include a contact pad on an upper surface thereof for contacting the printed circuit board. If desired, the printed circuit board can be disposed in the compartment above the battery. In a preferred embodiment, the power source (i.e., battery) can be provided adjacent to the printed circuit board, rather than beneath it, to reduce the overall height of the device. Moreover, the acoustical transducer can be disposed above the printed circuit board in the compartment. The acoustical transducer can achieve electrical communication with the printed circuit board by direct physical electrical contact with the board upon assembly of the device, or by way of one or more conductive leads or circuits connecting the acoustical transducer to the printed circuit board.

While a single aperture can be used in certain implementations, in other implementations the base portion can define a plurality of openings therethrough, such as proximate the lower face of the battery. At least one of the openings can be near the conductive lead, and a second opening can be near an exposed portion of the lower face of the battery. The plurality of openings are preferably configured to receive leads of a removable electrical charger. It will similarly be appreciated that conductors for charging the battery can extend proximate an outer surface of the base portion. Preferably, the base portion contains a connection for a USB or power cable adapted to charge the device, and more preferably, the base portion has two pin-hole sized openings adapted to receive a two-pronged USB or power cable which can be connected for charging the device. The circuitry can be contained entirely within the band and connect directly to the USB or power cable. Preferably, this connection can be polarity-oriented and retained by a magnetic connector. In other implementations, the connection may be made by a connector with two or more raised concentric circles, separated for power polarity; such a connector preferably retains connection to the device magnetically.

In some embodiments, the base portion can define a port therethrough for venting back pressure from the acoustical transducer. The base portion and upper portion can be composed principally of an electrically insulating material, such as polymeric materials, composite materials, and the like. In some implementations, the base portion and upper portion can be composed principally of a glass filled polymeric material.

In further accordance with the disclosed embodiments, components of the printed circuit board can be coated with one or more moisture resistant layer(s). Preferably, the printed circuit board includes a electronic microcontroller. The microcontroller can be configured to activate a voltage converter mounted on the printed circuit board when the microcontroller is actuated. The microcontroller can further be configured to not actuate the acoustical transducer for a predetermined period of time after the microcontroller is actuated. In accordance with further aspects, the microcontroller can be configured to enter a self-test mode after the microcontroller has been actuated for a first predetermined amount of time. Additionally or alternatively, the microcontroller can be configured to actuate the acoustical transducer after the microcontroller has been actuated for a second predetermined amount of time. For example, the microcontroller can be configured to actuate the acoustical transducer for a full alarm cycle after the microcontroller has been actuated for a predetermined amount of time.

In accordance with a further embodiment, the microcontroller can be further configured to communicate wirelessly with a mobile communications device during the alarm cycle and/or at another time. The mobile communications device can be a smart phone, tablet, communication system (e.g., first responder/police communication system) and the like. The smart phone or tablet can be provided with a software application (“app”) that can be used to modify settings on the wearable device and/or to diagnose the wearable device. For example, the app can be provided with graphical user interfaces and soft controls for monitoring aspects of the wearable device, such as the amount of power stored in the power source of the device to track progress of recharging the device or monitoring power levels during usage, and for displaying results of a diagnostic test. The wearable device and smart phone or tablet can each be provided, if desired, with a near field communication (“NFC”) tag to permit delivery of information of the mobile device (smart phone, tablet) to the wearable device when the device is turned off, wherein the wearable device can query the NFC tag after it is activated and read the information on the NFC tag. The mobile communications device can be configured to contact an emergency service after receiving a signal from the alarm module through the app or a different software program.

The ring can be further configured to cause the mobile device to determine and transmit its GPS coordinates upon actuation of the ring. If desired, the GPS coordinates can be transmitted with an alert message. The mobile device and ring can communicate bi-directionally as desired. The microcontroller can be configured to communicate wirelessly uni-directionally or bi-directionally with the mobile communications device using a Bluetooth communications protocol or WiFi communication link. If desired, the ring can be configured to send an alert message through the smart phone of another individual besides the wearer, such as through the communications device of an attacker or hostile individual. Specifically, the ring could contact a pre-selected target, such as by texting 911 or another suitable emergency number that can receive and process such a message, and can preferably access and transmit geolocation (GPS) coordinates obtained by the attacker's device to the pre-selected target location. While it will be appreciated that these modes of communication are typically unidirectional, it will be appreciated that the bidirectional modes of communication are also encompassed by the present disclosure. For example, the ring or wearable article can receive instructions, data or other programming from an external source, such as a remote terminal or mobile communications device. It will be further appreciated that any suitable feature from any patent application incorporated by reference herein can be integrated into any of the disclosed embodiments.

The disclosure further provides an alarm module that can be integrated into a wearable article, such as an article of jewelry or accessory, including a base portion, including a housing defining a compartment therein, a printed circuit board disposed in the compartment including circuitry for actuating at least one electrically driven accessory, a rechargeable power source in selective electrical communication with the at least one electrically driven accessory by way of the printed circuit board, an upper portion covering the compartment engaged with the base portion, and an electrical charging port defined through at least one of the base portion and the upper portion, the electrical charging port being in electrical communication with the rechargeable power source and being configured to removably receive an electrical charger. If desired, the electrically driven accessory can include an acoustical transducer mounted on the printed circuit board, and/or a lighting device and the like. In further embodiments, a wearable article can be provided including a wireless charging antenna for charging an onboard power source (e.g., capacitor or battery).

It is to be understood that both the foregoing general description and the following detailed description are exemplary and are intended to provide further explanation of the embodiments disclosed herein.

### BRIEF DESCRIPTION OF DRAWINGS

FIG. 1A depicts a first exploded view of an exemplary embodiment of a wearable article in accordance with the disclosure in the form of a finger ring illustrating all components of the device, and FIG. 1B illustrates an exploded view of select components of the finger ring;

FIGS. 2A-2D depict various perspective views of a base portion of the finger ring of FIGS. 1A-B, and FIGS. 2E-2F are selected cross sectional views of the base portion;

FIGS. 3A-3B depict perspective shaded and wireframe top perspective views, respectively, of an upper portion of the finger ring of FIGS. 1A-B,

FIGS. 3C-3D depict perspective shaded and wireframe bottom perspective views, respectively, of an upper portion of the finger ring of FIGS. 1A-B,

FIG. 3E is a cross-sectional view of the base and upper portions of the finger ring of FIGS. 1A-1B showing alignment and fit of the components;

FIGS. 4A-4B depict perspective shaded and wireframe top perspective views, respectively, of an interior rotor component of the finger ring of FIGS. 1A-1B that fits inside of the base and upper portions;

FIGS. 4C-4D depict perspective bottom and plan front views, respectively, of the rotor component;

FIGS. 4E-4F depict right plan and further perspective bottom views, respectively, of the rotor component;

FIGS. 4G-4H depict side and cross sectional views, respectively, of the rotor component;

FIGS. 4I-4J depict cross-sectional and top views, respectively, of the rotor component;

FIG. 5A depicts a perspective view of the rotor component with a centering ring fitted around it containing a small permanent magnet, with a printed circuit board positioned inside the rotor component;

FIG. 5B is a top view of the printed circuit board;

FIG. 5C is a schematic view of the electrical system of the finger ring of FIGS. 1A-1B;

FIGS. 6A-C are various perspective views of the centering ring component of the finger ring of FIGS. 1A-1B;

FIGS. 7A-B are top and bottom perspective views of a charger that can be used for charging the finger ring of FIGS. 1A-B particularly illustrating exemplary connection points and retention structure(s). FIG. 7C is an alternative embodiment of a charger;

FIG. 7D is a top perspective view of the finger ring of FIGS. 1A-1B connected to the charger of FIGS. 7A-7B;

FIG. 8 is an exemplary data flow diagram illustrating communication paths within a system utilizing the finger ring of FIGS. 1A-B;

FIG. 9 is an exemplary computer systemization of the system of FIG. 8;

FIGS. 10 and 11A-11C depict bottom and top plan views, and side and front elevational views of another exemplary embodiment of a wearable article in accordance with the disclosure in the form of a wristband; and

FIG. 12 is a schematic view of the electrical system of the wristband of FIGS. 10 and 11A-11C.

### DETAILED DESCRIPTION

Reference will now be made in detail to the present preferred embodiments of the disclosure, examples of which are illustrated in the accompanying figures.

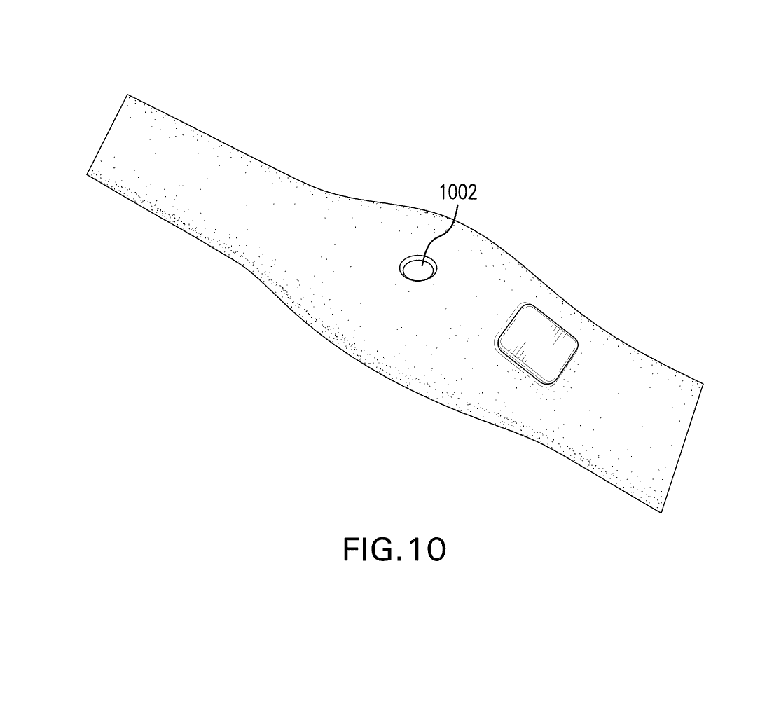

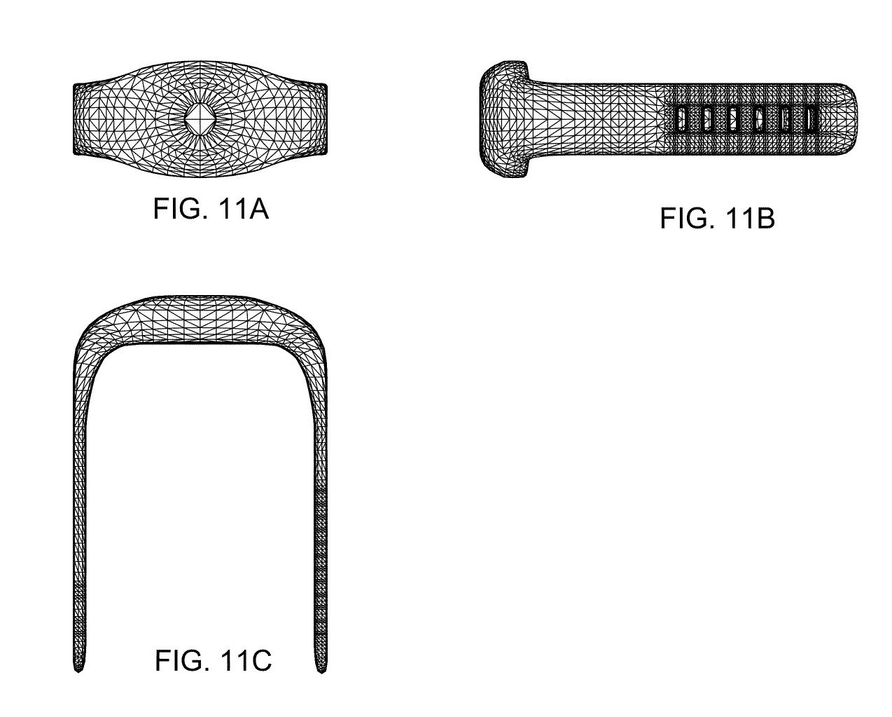

The embodiments of the present disclosure can be used for a variety of purposes. In accordance with a preferred embodiment, the disclosure provides a wearable device that preferably includes an intense auditory alarm—preferably 110 db or louder, at close proximity—that can be selectively actuated by a wearer. Additionally or alternatively though, the wearable device can have additional or alternative devices, including but not limited to a bright illuminated flash powered by a power supply to temporarily blind/disorient an assailant, GPS functionality, Bluetooth® communication capability and features, Near Field Communication (“NFC”) features, circuitry for communication via cellular radio and telephone, among other things. The alarm module device can be integrated, for example into or onto an article of jewelry, such as a finger ring, a time piece (e.g., wristwatch), a pendant (e.g., clipable or wearable on a chain), a bracelet, and the like. The alarm module device can be attached or attachable to a sport band (e.g., silicone or elastomeric wrist or ankle band), and the like, as seen in FIGS. 10-11C. Preferably, the band is made of neoprene or an elastomeric material, and can be provided with a geometric patterning or texture for aesthetic appearance. By providing a band of elastomeric or other flexible, moldable material, the article can be slipped onto wearer, i.e., on the wearer's wrist, without the requirement for mechanical locking means or metal casting.

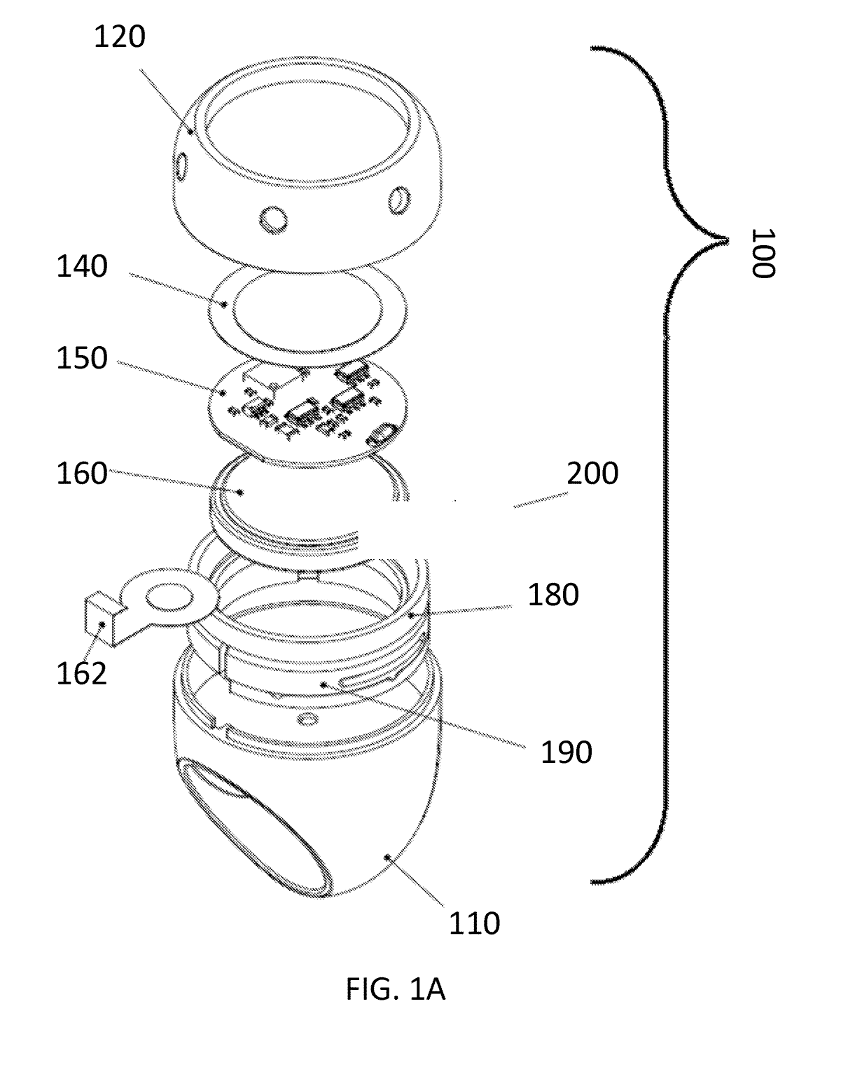

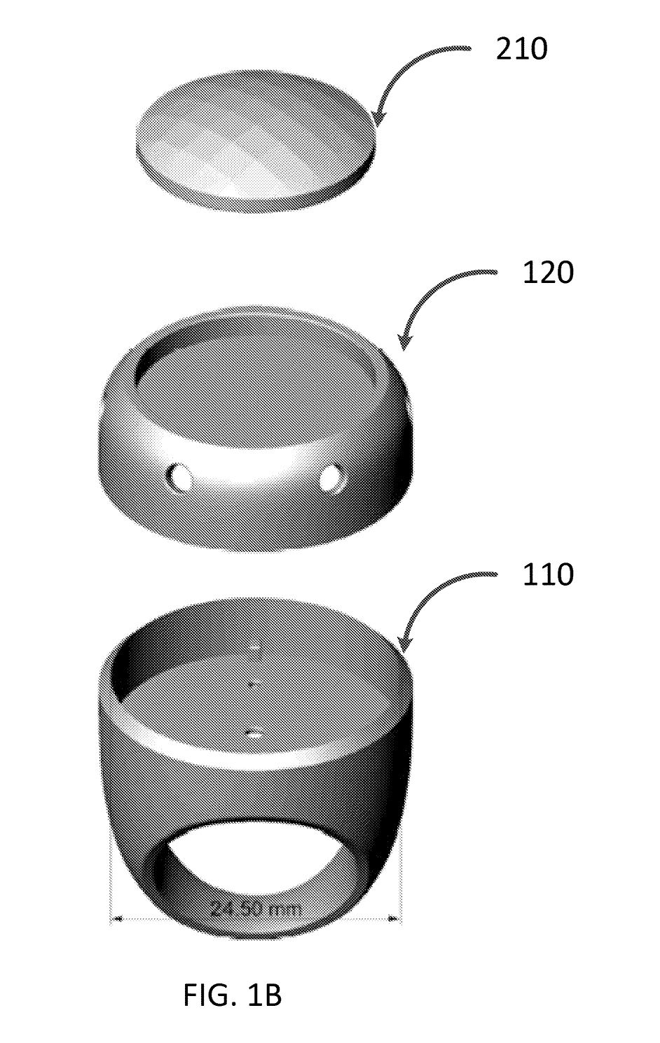

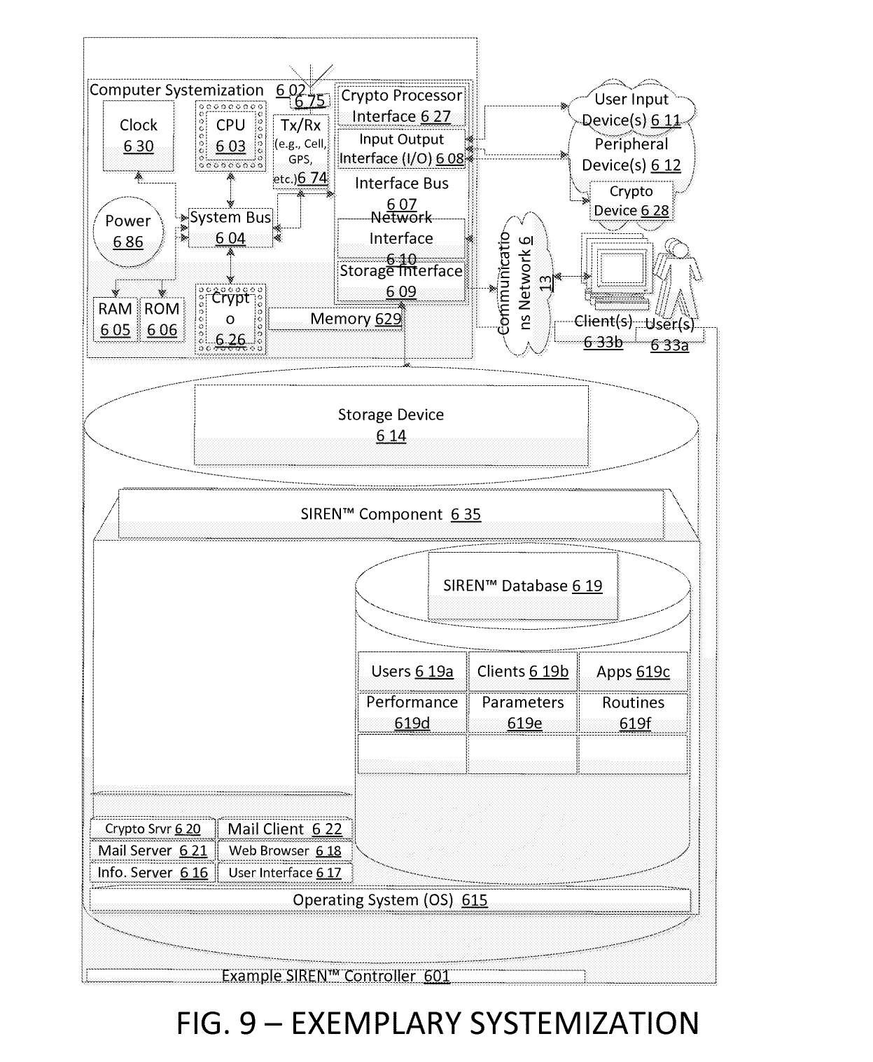

For purpose of illustration and not limitation, a first embodiment of the device made in accordance with the present invention is illustrated in FIGS. 1-8. A computerized systemization for a system for operating systems including the ring is illustrated in FIG. 9.

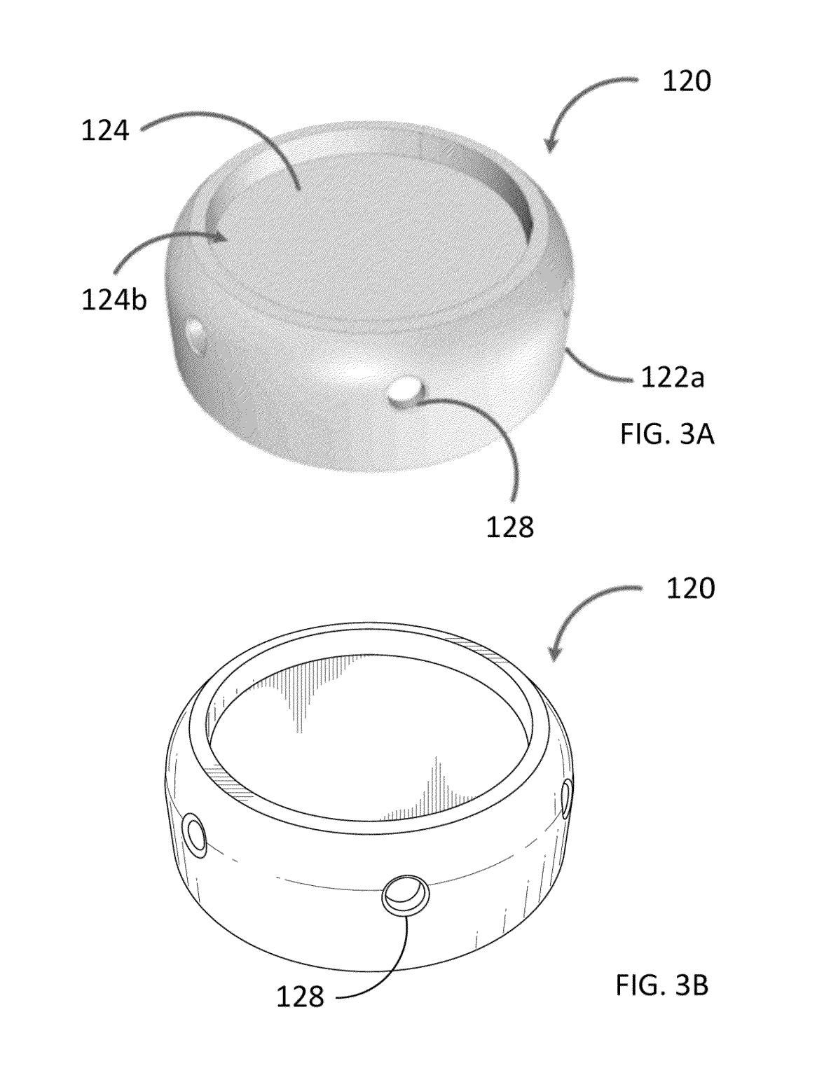

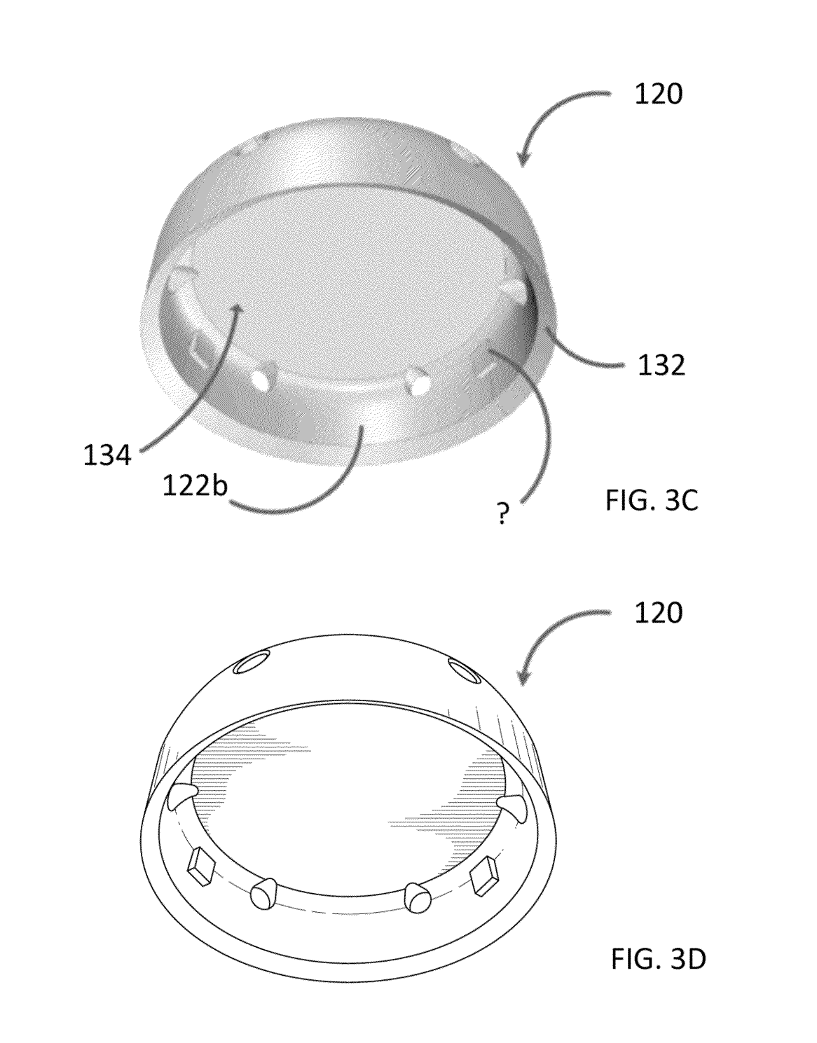

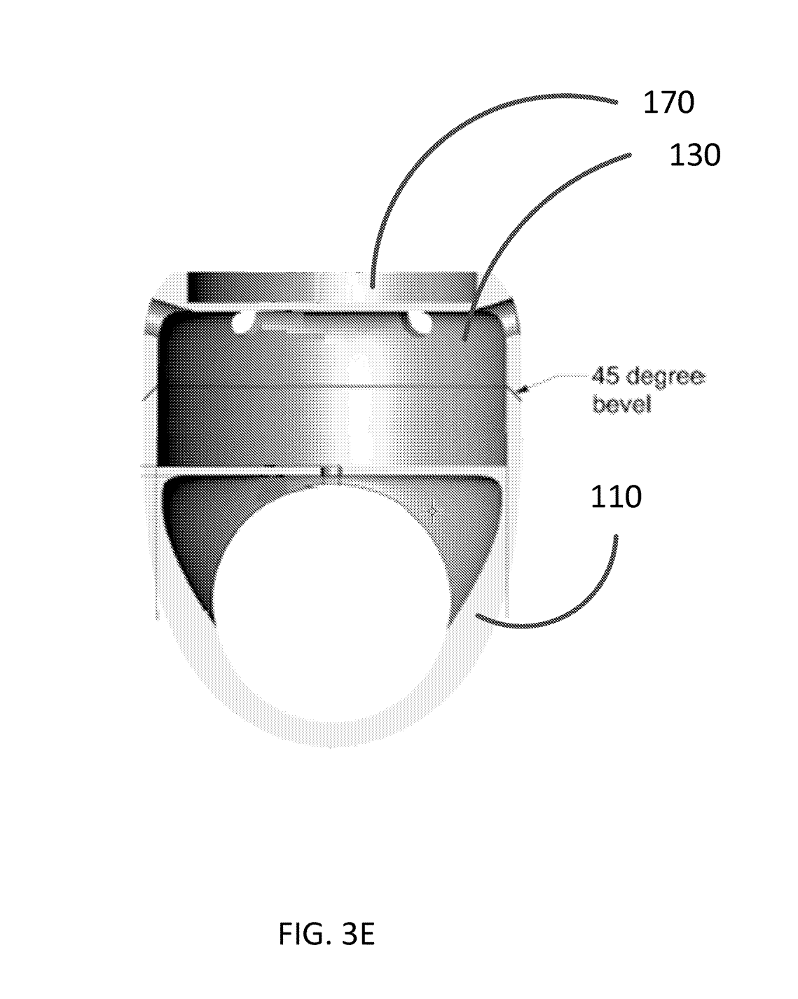

For purposes of illustration, and not limitation, FIGS. 1A-B illustrate exploded views of an alarm module device integrated into an article of jewelry in the form of a finger ring 100. Specifically, FIG. 1A depicts a first exploded view of an exemplary embodiment of a wearable article in accordance with the disclosure in the form of a finger ring illustrating all components of the device, and FIG. 1B illustrates an exploded view of select components of the finger ring. The device 100 can include a base portion 110 and an upper portion 120 covering the base portion 110, wherein the base portion 110 and the upper portion 120 cooperate to define an interior compartment 130 for housing functional components of the device. The device 100 can further include at least one acoustical transducer 140, and a printed circuit board 150 (or other suitable activation circuitry) disposed in the compartment 130 (FIG. 3E) including circuitry for actuating the at least one acoustical transducer 140. The device can further include a power source 160 in selective electrical communication with the at least one acoustical transducer 140 by way of the printed circuit board 150.

The device too can further include one or more ornaments 210, such as a simulated or real jewel(s) a college or university logo (e.g., such that the ring is a school class ring), and the like. As such, the ornament may be a stone, artwork (such as cloisonné, painted ceramics and other such designs) electronics device (such as a coin style watch) or any other item desired. In some embodiments, the ornament can be interchangeable such that a user may select an ornament that is appropriate for a particular occasion or mood.

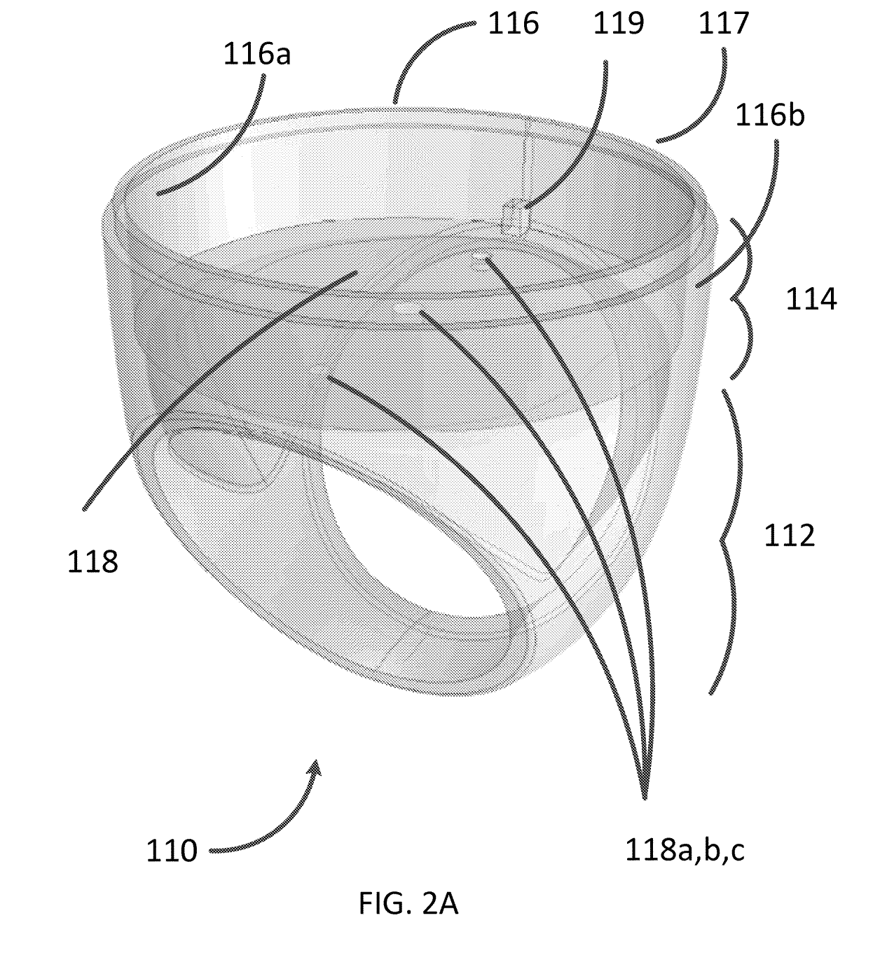

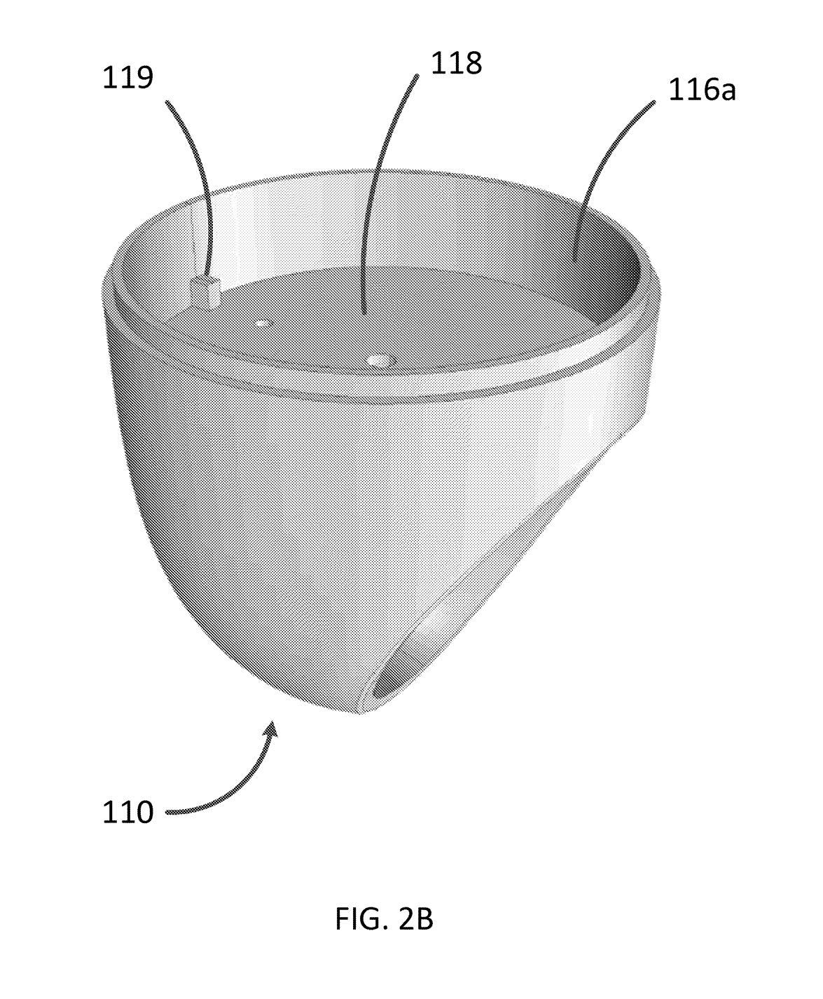

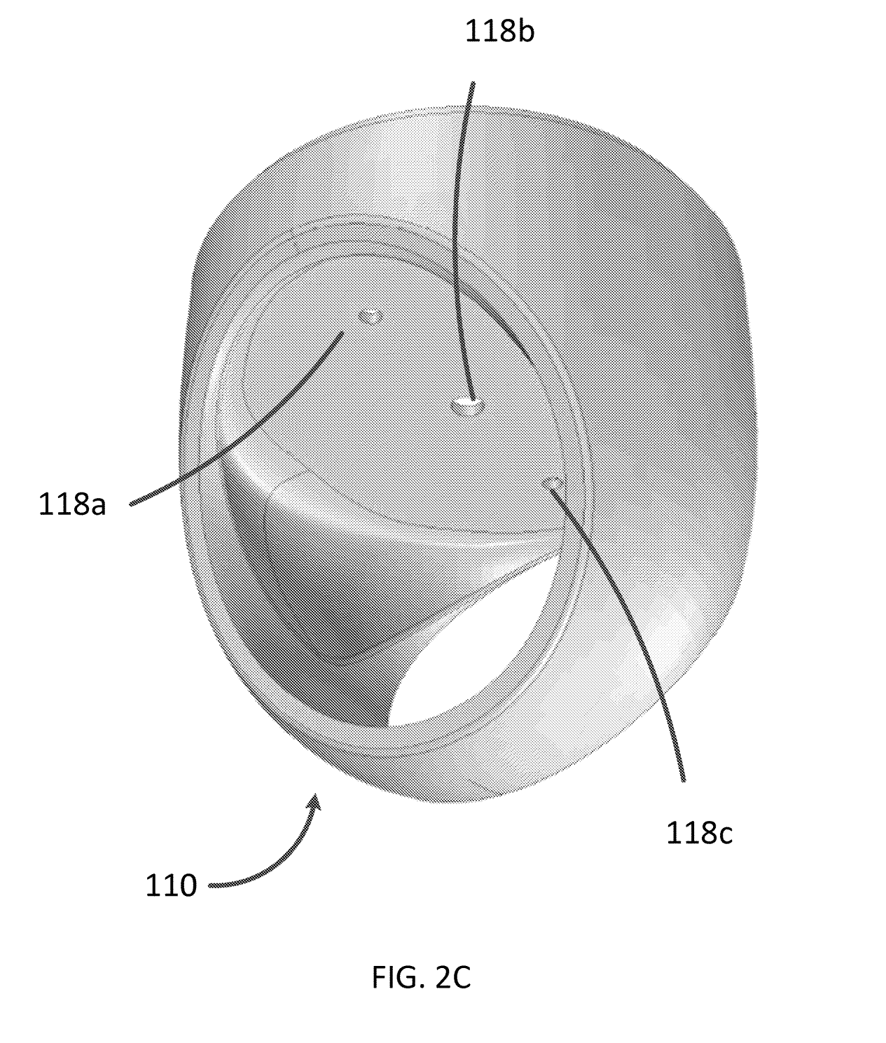

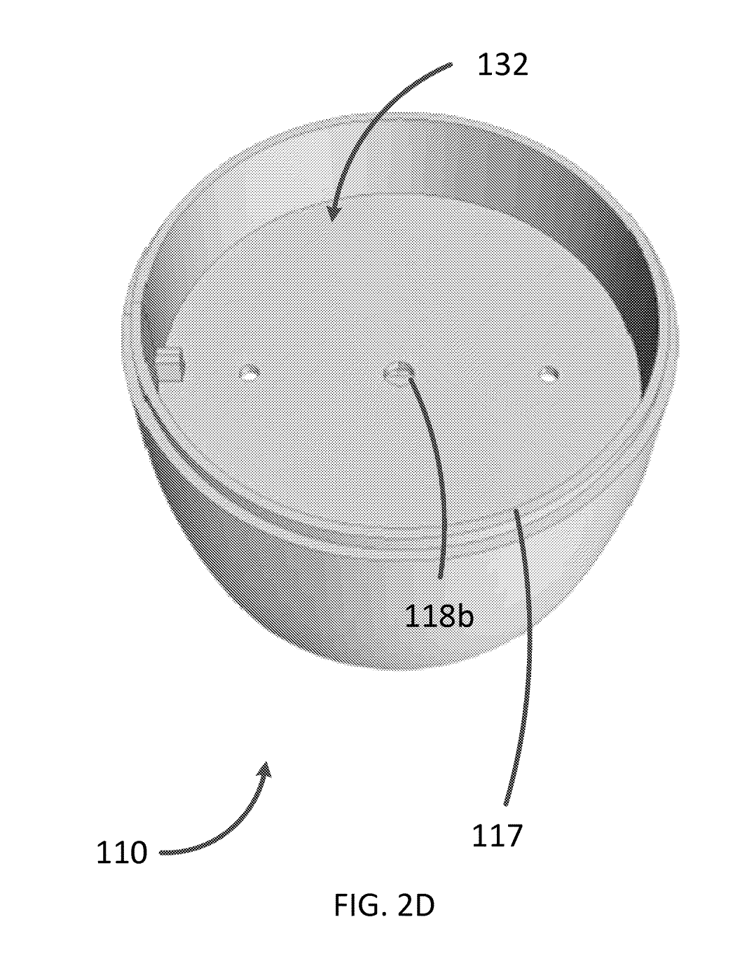

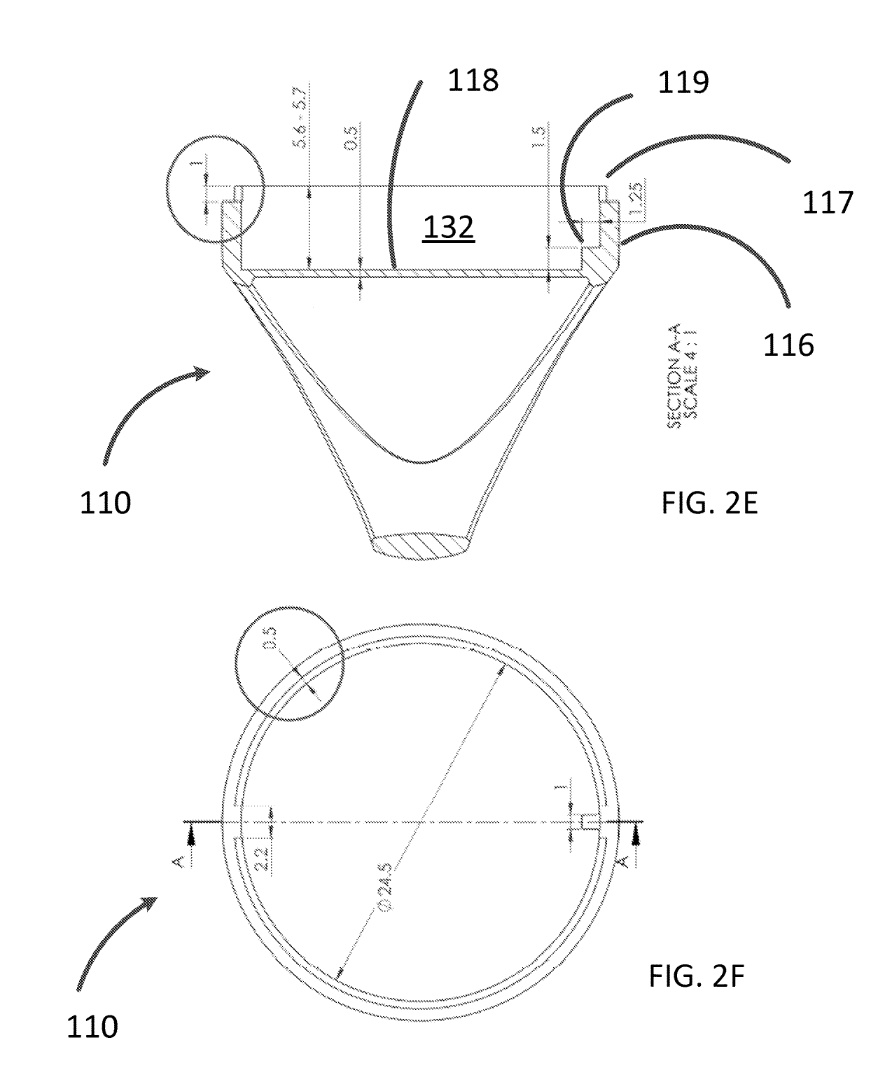

FIGS. 2A-2F are exemplary illustrations of the base portion 110. As illustrated, base portion 110 includes a lower portion that includes a ring shaped body 112 having a finger passage defined therethrough that is integrated with an upper portion 114 defined by an outer peripheral wall 116 having an inner surface 116a and an outer surface 116b and a floor 118 defining one or more openings therethrough 118a, b, c to permit passage of portion of an electrical charger therethrough and/or to vent back pressure produced by the acoustical transducer 140. Preferably, the base portion contains two pin-hole sized openings adapted to receive a two-pronged USB or power cable which can be connected for charging the device; alternatively. In an alternate embodiment, the connection can be made by the concentric circle connector referenced above. The base portion 110 can be monolithic, as presented, and be either machined from a solid block of material or injection molded, as desired. Alternatively, the base portion 110 may be assembled from a plurality of individual components. The base portion 110 can be made from metal, plastic or composite material, as desired. Preferably, the base portion 110 is made from a dielectric (electrically insulating) material, such as glass filled polymeric material. As further illustrated in FIG. 2A, the base portion 112 can define one or more interior alignment bosses 119 for interfitting with other components of the device. As illustrated, base portion 110 further includes a stepped edge 117 including an inner annular wall that extends upwardly beyond wall 116.

As illustrated in FIGS. 3A-D, the upper portion 120 is generally bowl shaped having an outer cylindrical surface 122a formed by a circumferential wall 122 and a top wall 124 having an outer surface 124a that may be provided with a recess 124b for receiving a decorative element 210, such as a faux jewel, seal, and the like. The upper portion 120 further includes interior cavity 134 defined by an inner surface 122b of wall 122 and a lower surface 124b of top wall 124. One or more of the upper portion 120 and base portion 110 can define a resonant chamber 170 for the acoustic transducer 140. The upper 120 (and/or base 110) portion can still further define at least one acoustical passage 128, such as through the side wall 122 and/or top wall 124 to facilitate transmission of acoustical energy generated by the acoustical transducer 140 from inside the resonant chamber 170 to a location outside of the wearable article 100. As illustrated in FIG. 3E, the base portion 110 can define a first cavity therein 132, and/or the upper portion 120 can define a second cavity 134 therein. The first and/or second cavity 132, 134 can cooperate to define the compartment 130. If desired, the interface between the base portion 110 and the upper portion 120 can have a beveled cross sectional profile as illustrated, have a “step” or sawtoothed cross section, or the like. Moreover, an environmental seal (e.g., silicone annular seal) can also be provided within the interface. In accordance with a further aspect, the upper portion 120 can be rotatably displaceable with respect to the base portion 110. In various embodiments, the acoustical transducer 140 can be actuated by rotating the upper portion 120 with respect to the base portion 110, as such an activation process helps prevent unintentional actuation. However, it will be appreciated that any suitable actuation technique can be used.

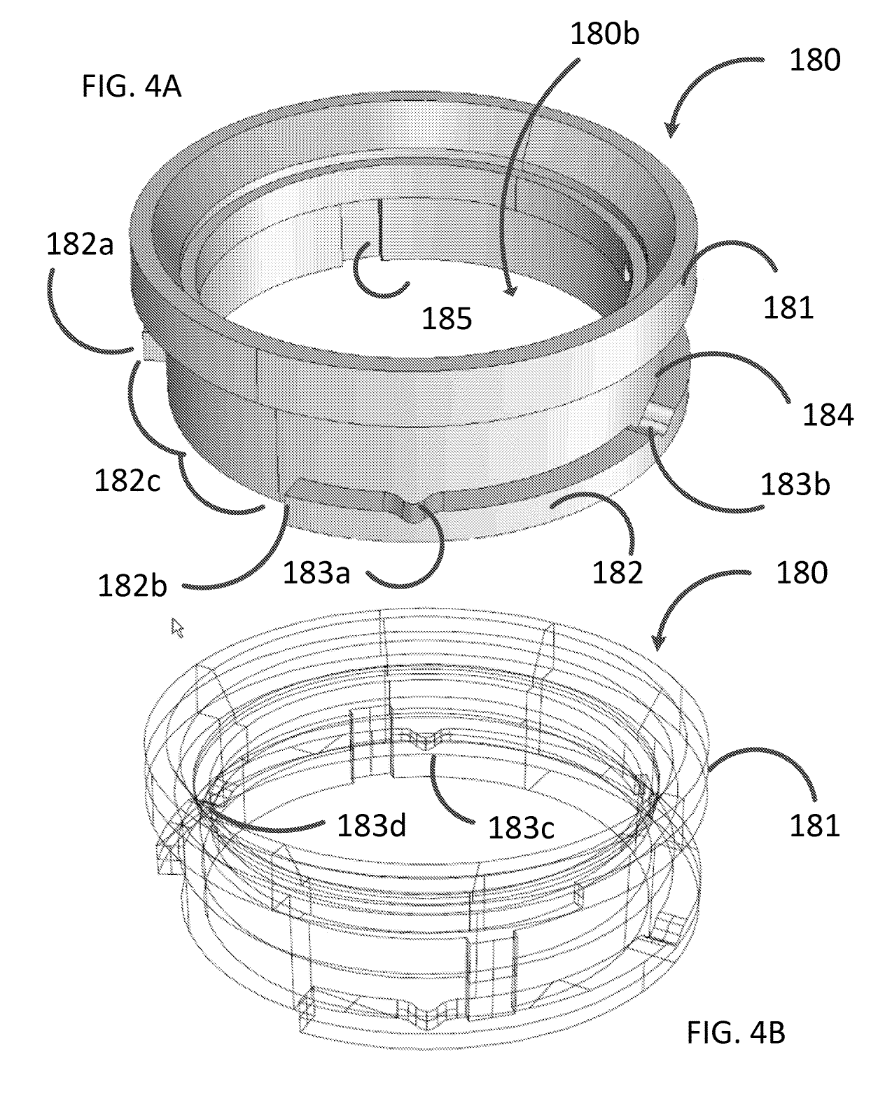

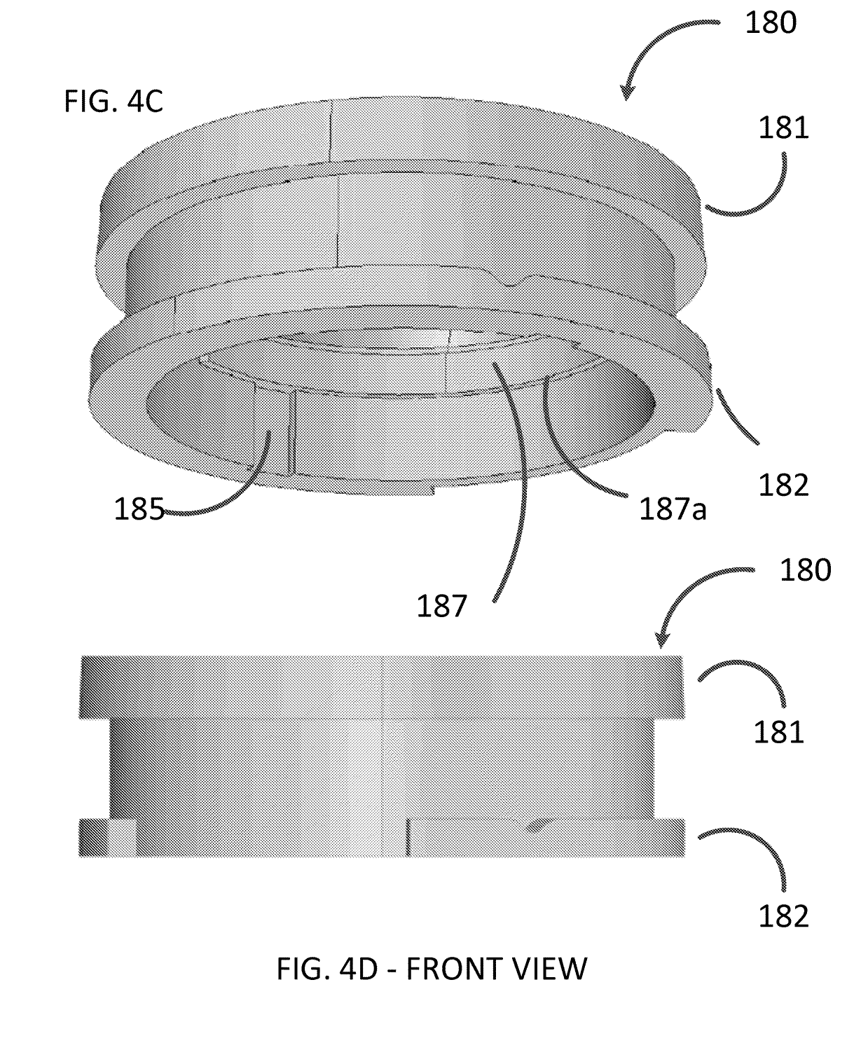

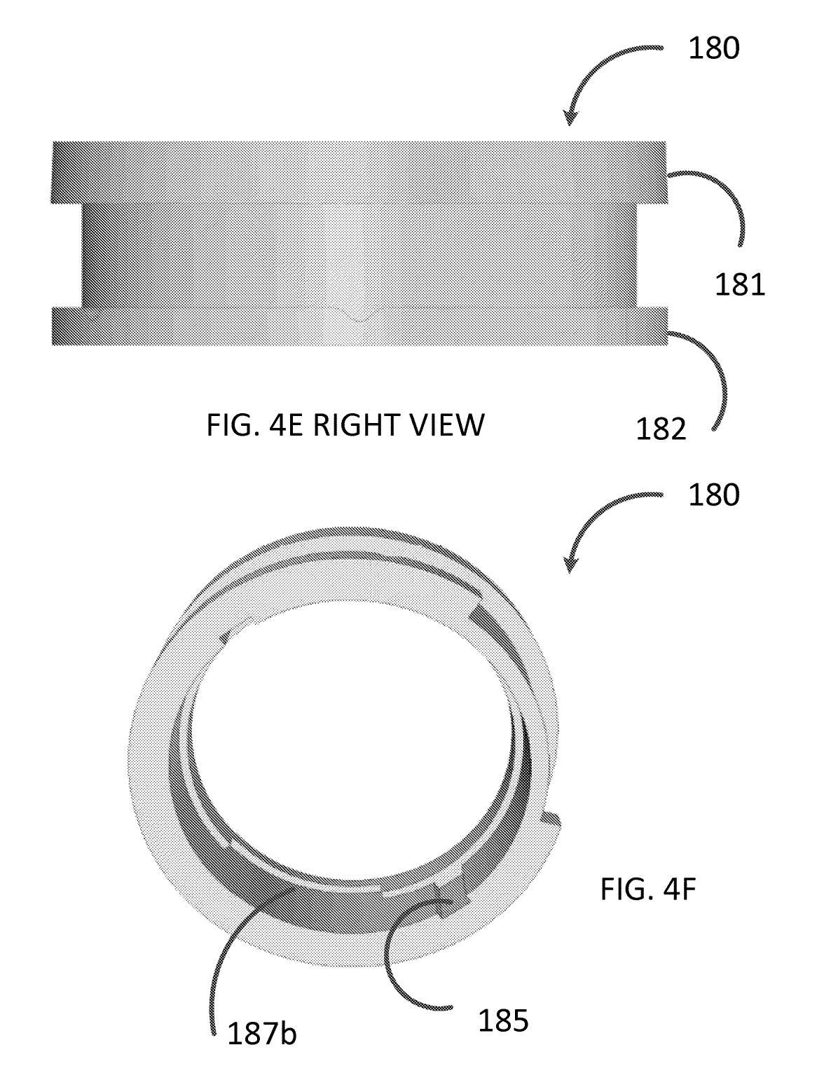

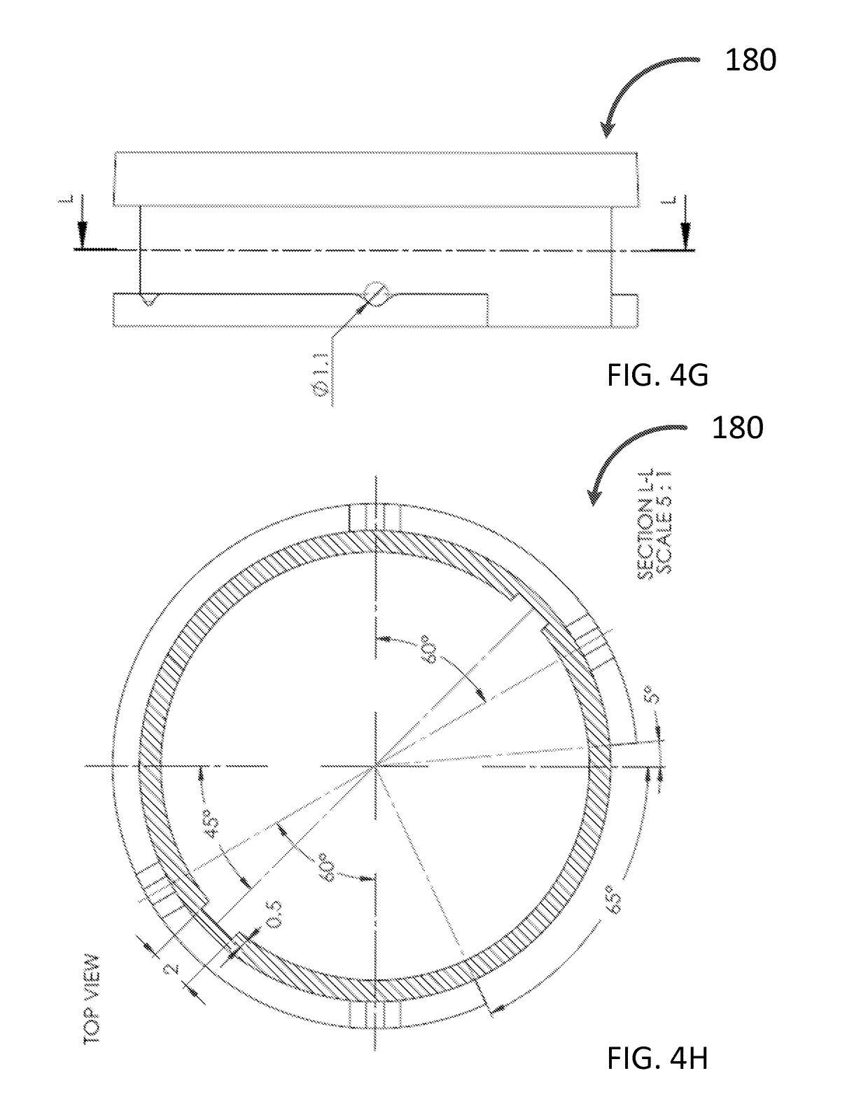

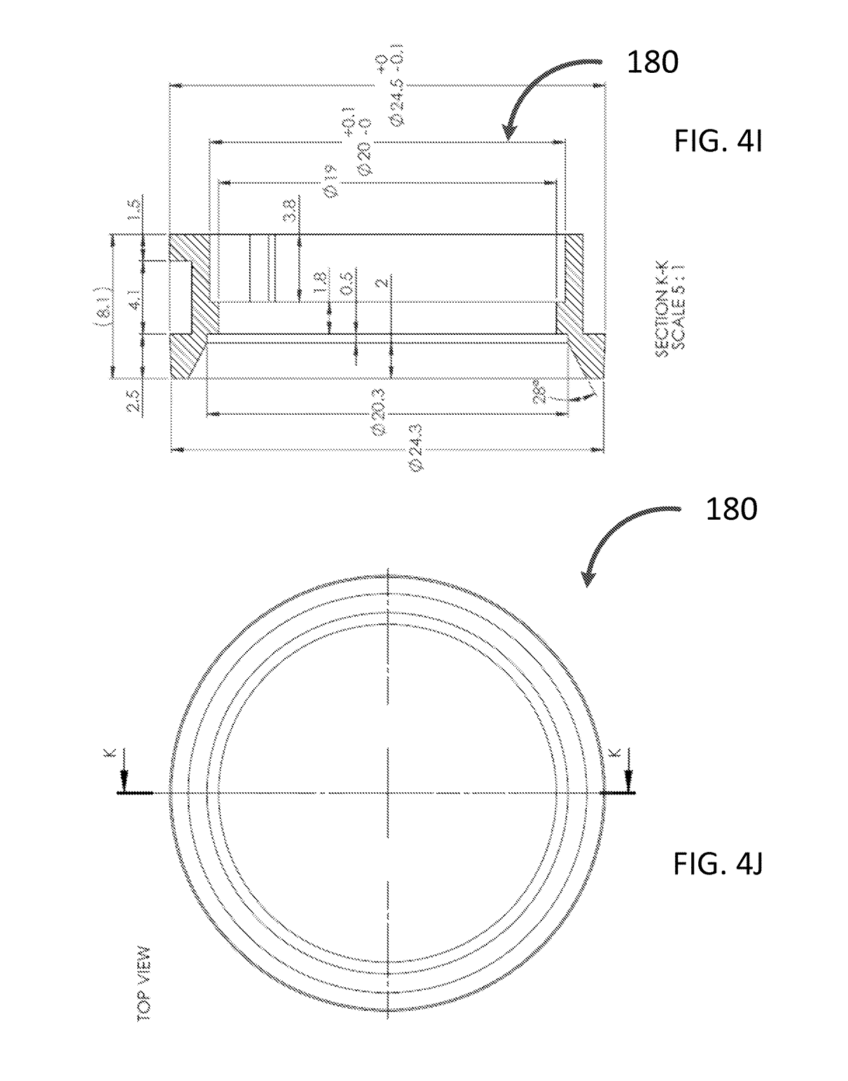

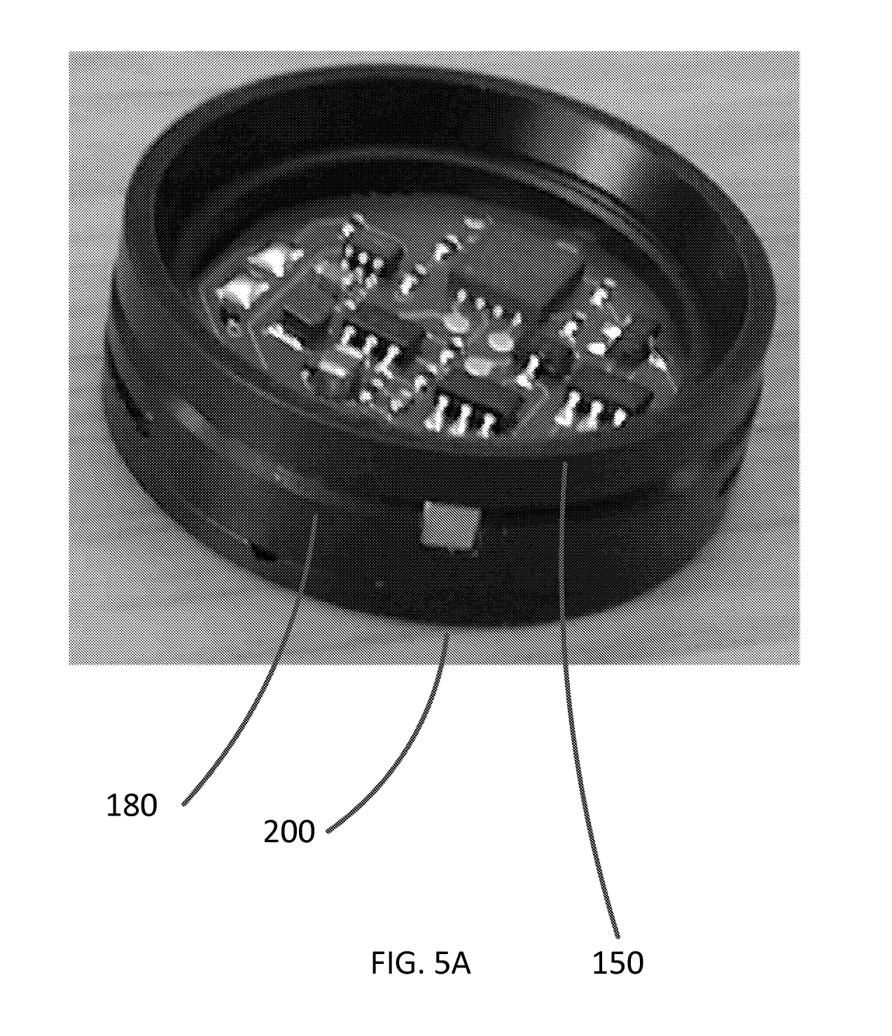

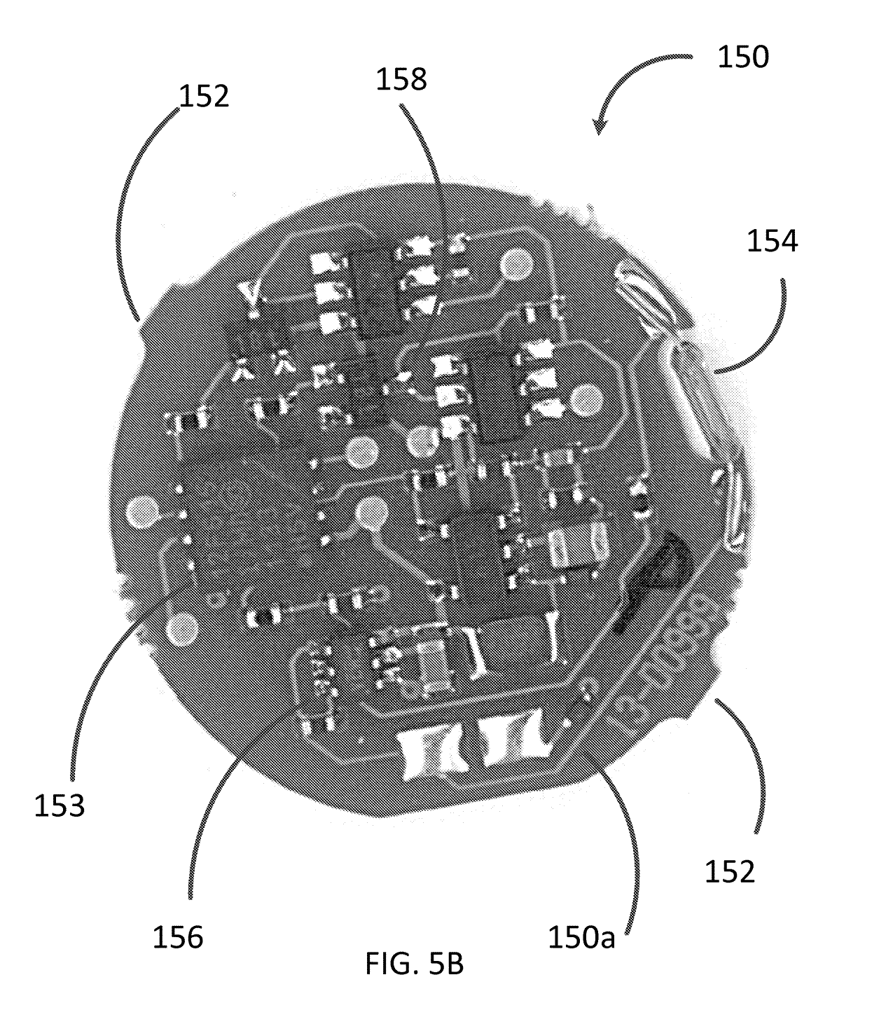

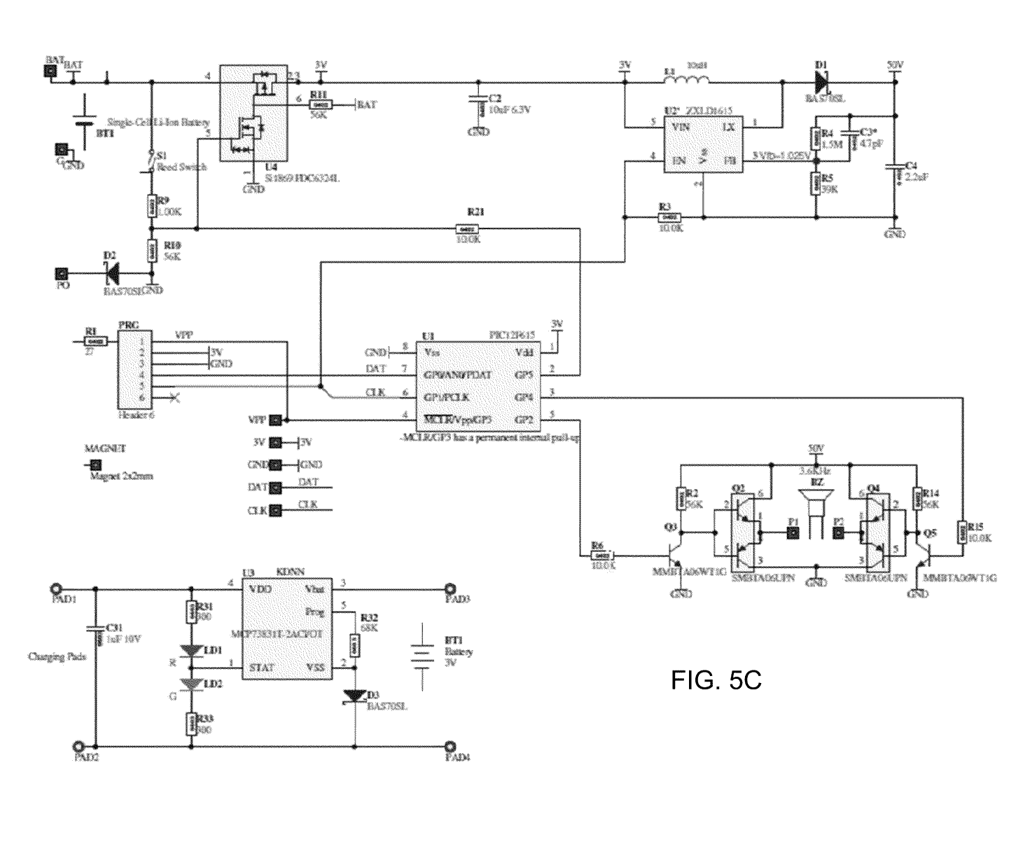

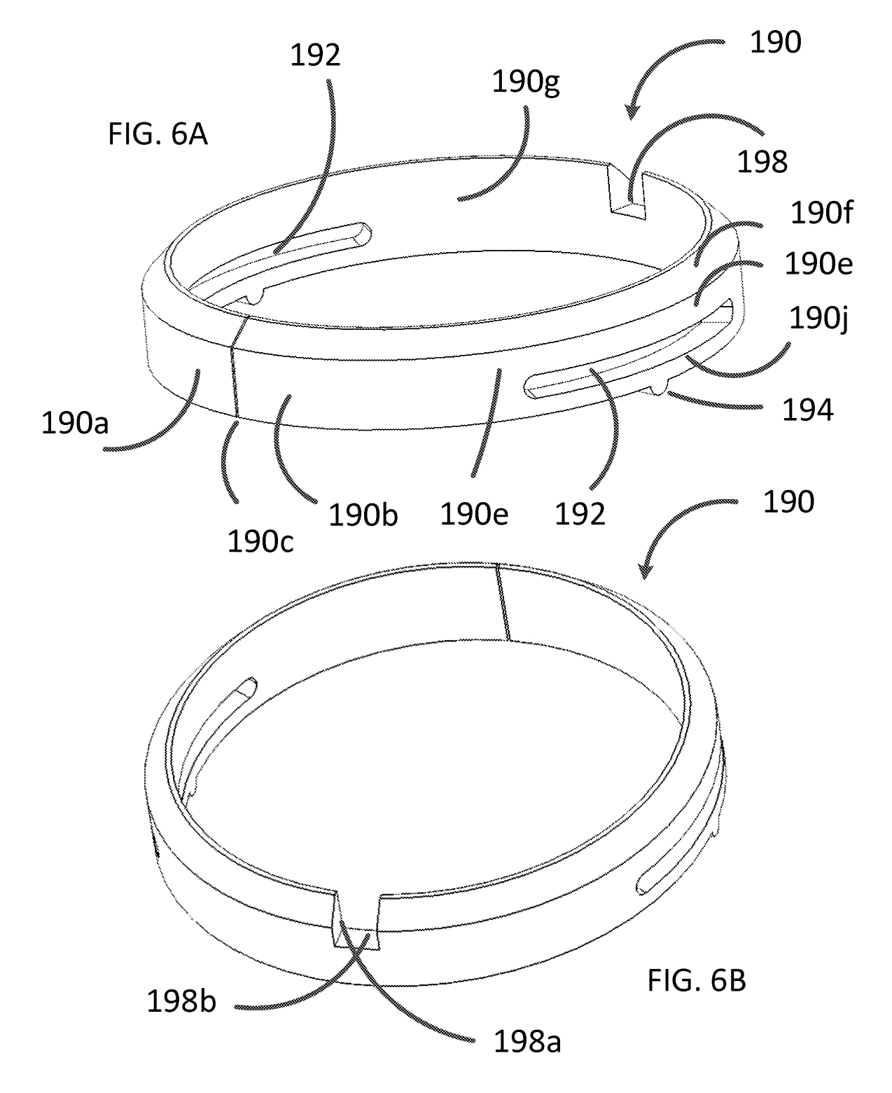

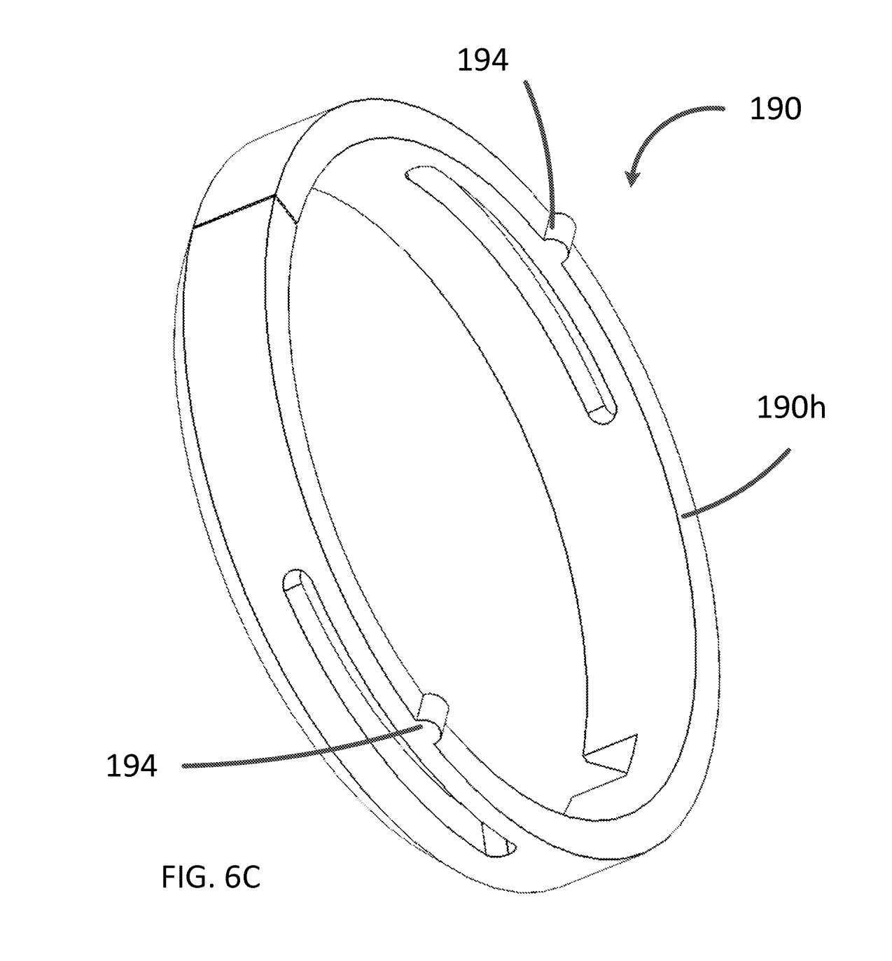

For purposes of illustration, and not limitation, an exemplary rotor component 180 is depicted in FIGS. 4A-4J. As illustrated, rotor 180 includes an annular body defining a continuous annular flange 181 about its upper periphery, and a discontinuous lower flange 182 about its lower periphery, in turn having a first circumferential end 182a and a second circumferential end 182b separated by a gap 182c. Lower flange 182 defines a plurality of notches therein 183 a, b, c, d for receiving protrusions 194 of centering ring 190 (FIGS. 6A-C). The rotor 180 can be provided with a track 184 such as an annular groove, as illustrated, for receiving the centering ring 190. The rotor 184 can further be provided with one or more interior channels 185 for receiving alignment bosses 152 of printed circuit board 150 therein. Printed circuit board 150 is thus received within the bore 180B of rotor 180, and the periphery of upper surface 150a of printed circuit board 150 physically contacts the lower face 187a of inner annular protrusion 187. Inner annular protrusion 187 further defines a notch 187b along a portion of its lower extent to permit clearance for reed switch 154 of printed circuit board 150. In FIG. 5A, the printed circuit board 150 is illustrated disposed in its preferred orientation within annularly shaped rotor 180.

If desired, the rotor 180 can be connected to or otherwise be in rotatable contact with the upper portion 120 (e.g., by interference fit, snap fit, adhesive, or the like) so that the rotor 180 rotates with the upper portion 120 when the upper portion 120 is rotated. The rotor 180, combined with the upper portion 120, PCB 150 and other ring components can then be positioned within the base portion 110 and aligned with surface features (e.g., boss 19) of the base portion no to ensure proper orientation. Once the resonator 180 has been placed within base portion 110, an upper edge (e.g., 117) of the base portion 110 may be peened over the rotor 180 in order to ensure retention thereof. Other techniques for retention of the rotor 180 within the base portion may be used, as desired, such as adhesives, interference fit, threaded connections, and the like.

In some implementations, the rotor 180 can be disposed within a centering ring. For purposes of illustration, and not limitation, various views of an exemplary centering ring 190 in accordance with the disclosure is presented in FIGS. 6A-6C individually, and shown installed over the rotor 180 in FIG. 5A. As depicted, the centering ring 190 includes a split ring body having first and second ends 190a, 190b that are separated by a gap 190c. The centering further defines an angled upper annular surface 190d that connects vertical outer side surface 190e to upper peripheral edge 190f, which in turn is connected to inner annular wall surface 190g. As depicted in the lower perspective view of FIG. 6C, centering ring 190 is further defined by lower flat annular wall 190h. Centering ring further defines one or more deflection grooves 192 therein, explained in further detail below, and preferably includes one or more protrusions 194 on the lower face 190h of centering ring 190. Centering ring 190 can further define a receiving notch 198 for receiving magnet 200 for selectively activating the reed switch 154 on the printed circuit board to activate the system, as discussed elsewhere herein. As depicted, notch 198 is defined by side walls 198a joined by a lower wall 198b. The gap 190c can fit around a protrusion (e.g., boss 119) in the base no to prevent the centering ring 190 from rotating with respect to the base portion no when the rotor 180 rotates with the upper portion 120 with respect to the base portion 110. In other embodiments, the centering ring 190 can be pinned into the base portion 110 or otherwise prevented from rotating with respect to the base portion, such as via interference fit, adhesives, and the like.

In some implementations, the rotational position of the rotor with respect to the centering ring can be maintained in the first and/or second rotational positions by first and second detents.

For purposes of illustration, and not limitation, detents (detent mechanisms) are formed by the coupling of the notches 183 a, b, c, d of the rotor 180 and the protrusions 194 of the centering ring 190 acting in cooperation with the grooves 192 of the centering ring. Accordingly, the detents can include circumferential deflection groove(s) 192 formed into the centering ring (or the rotor 180, if desired), separating upper and lower ring portions 190i, 190j of the centering ring 190. The detent can be energized by compressing the upper and lower ring portions 190i, j together into the deflection groove, although in the illustrated embodiment, the majority or all of the deflection is effectuated by deflection of the lower ring portion 190j. In some embodiments such as the illustrated one, the deflection grooves 192 can pass all the way through the centering ring 190 from a radially outer surface 190e of the centering ring 190 to a radially inner surface 190i of the centering ring 190 along part or all of the circumferential extent of the deflection groove 192. Permitting some solid material to remain within the groove 192 can increase resistance to deflection of the lower ring portion 190j. Accordingly, the rotor 180 (and PCB 150 and upper portion 120) can be rotatably displaced with respect to the centering ring 190 (and base portion 110) from a first rotational position to a second rotational position, wherein the detents are engaged in both positions by virtue of having four notches 183 in rotor 180.

If desired, the protrusions 192 can be formed on either or both of the upper and lower ring portions 190i, 190j, with complementary notches being provided in the upper and lower flanges of the rotor 180, respectively. However, if desired, the arrangement can be reversed, and the deflection grooves can be formed into the rotor 180 and the notches can be formed into the centering ring 190.

In some implementations, the centering ring 190 can include a magnetic portion 200, such as a permanent magnet inserted into and/or onto a portion of the centering ring 190. In such embodiments, the printed circuit board 150 can include a magnetically activated switch 154 mounted thereon or in electrical communication with the printed circuit board 150 to facilitate the delivery of electrical power from the power source 160 to the acoustical transducer 140. The magnetically activated switch 154 can be actuated when the magnetic portion 200 of the centering ring 190 is placed in close proximity with the magnetically activated switch 154. The magnetically activated switch 154 can thus be actuated when the rotor 180 is rotatably displaced with respect to the centering ring 190 from a first rotational position, wherein the magnetic portion 200 is not near the switch 154, to a second rotational position, wherein the magnetic portion 200 is close enough to the switch 154 to actuate it. The magnetically activated switch 154 can include a reed switch, for example. As will be appreciated, the presence of four notches 183 on the upper surface of the lower flange of the rotor permits the illustrated rotor to be set to two different rotational positions with respect to the centering ring. In a first position where the two detents mechanisms are engaged, the magnet 200 is close enough to the reed switch 154 to activate it, and hence, activate the electronics in the ring. In the other rotational position, the detents hold the ring in an off position wherein the magnet 200 is rotationally displaced from the reed switch.

In various implementations, the acoustical transducer 140 can be disposed wholly or partially inside and/or outside the compartment 130. For example, the acoustical transducer 140 can be wholly contained within the compartment 130, or if desired, the acoustical transducer 140 can be disposed on an exterior portion of the device 100. For example, in some embodiments, the acoustical transducer 140 can be integrated with or be made to resemble a faux jewel 210 or other decorative portion of the device 100. One example of a suitable acoustical piezoelectric transducer 140 is provided in Table 1 below.

TABLE 1
Exemplary Piezoelectric Transducer

| | OPT-BD- | | |
|---|---|---|---|
| Part Number | 20T-3.9A3 | | |
| Disk | Brass | Resonant frequency | 3.9 +/− −0.5 |
| | | (kHz) | |
| Outer diameter | 20 | Impedance Ohms | 300 |
| (MM) | | (max) | |
| PZT O.D. (mm) | 15 | Capacitance | 25,000 |
| | | (pF @ 1 kHz) | |
| Thickness (mm) | 0.22 | Input voltage | 100 |
| | | (p-p max) | |
| Disk thickness (mm) | 0.1 | | |

In some embodiments, the transducer 140 is a commercially available product. In some other embodiments, the piezoelectric transducer is custom manufactured for use in the ring to in order to provide greater output.

The printed circuit board (“PCB”) 150 is illustrated in physical format in FIGS. 5A-5B, and in schematic format with the rest of the electrical components in FIG. 5C. The PCB 150 includes a microcontroller 153 that is programmed to control all of the electronic functions of the device too, a reed switch 154 to act as a triggering mechanism for activating the system when placed in proximity with magnet 200, a voltage convertor 156 for stepping up the voltage level from the battery to a level sufficient to drive the piezoelectric transducer, a transistor pair 158 to act as a balanced bridge output amplifier, and other various passive circuit components. PCB 150 also includes alignment bosses 152 to be aligned with and received by alignment channels 185 in rotor 180. FIG. 5C presents an electrical schematic for the various electrical components of the system, and Table 2 below summarizes the identity and relevant parameters for each component:

TABLE 2

| Designator | Comment | Value | Manufacturer PN | Location | Description |
|---|---|---|---|---|---|
| 3V, BAT, CLK, DAT, | B, G, GND, | PADS on PCB | PADS on PCB | | Terminal |
| G, GND, P1, P2, P3, | PA, PO, Test | | | | |
| P4, PAD1, PO, US1, VPP | point, VPP | | | | |
| BT1 | Single-Cell | 3.7 V LIR | LIR2032 | | Single-cell |
| | Li-Ion Battery | | | | Li-Ion Battery |
| BZ | 3.6 KHz | PIEZO | custom | | transducer |
| | | ELECTRIC | | | |
| | | element | | | |
| | | 3.6 KHz 20 mm | | | |
| C2 | 10 uF 6.3 V | 10 uF 6.3 V 0603 | GMC10X5R106M6R3NT | | Ceramic Chip |
| | | | | | Capacitor |
| C3* | 4.7 pF | 4.7 pF 50 V 0402 | CL05C4R7CB5NNNC | | Ceramic Chip |
| | | | | | Capacitor |
| C4 | 2.2 uF | 2.2 UF 50 V 0805 | C2012Y5V1H225Z | | Ceramic Chip |
| | | | | | Capacitor |
| C31 | 1 uF 10 V | C0603C105Z8V | C0603C105Z8V | | Ceramic Chip |
| | | | | | Capacitor |
| D1, D2, D3 | BAS70SL | BAS70SL | BAS70SL | | Schottky Diode |
| L1 | 10 uH | 10 uH 620 mA 0806 | Vishay | | Inductor |
| | | | (IFSC0806AZER100M01) | | |
| LD1 | R | RED 1206 | S1206RSAJC | J-158 | RED SMT LED |
| LD2 | G | Green 1206 | L-C170KGCT-U1 | J-158 | Green SMT LED |
| MAGNET | Magnet | 103MG5, 104MG1 | 103MG5, 104MG1 | | Terminal |
| | 2 × 2 mm | | | | |
| PAD3, | Test point | 0910-0-57-20- | 0910-0-57-20- | | |
| PAD4, US11 | | 76-14-11-0 | 76-14-11-0 | | |
| Q2, Q4 | SMBTA06UPN | SMBTA06UPN | SMBTA06UPN | | NPN/PNP |
| Q3, Q5 | MMBTA06WT1G | NPN 80 V 100 mA | MMBTA06WT1G | | NPN Bipolar |
| | | | | | Transistor |
| R2, R10, | 56K | 56K 1% 0402 | RC0402JR-0756KL | | Chip Resistor |
| R11, R14 | | | | | |
| R3, R6, | 10.0K | 10.0K 1% 0402 | RC0402FR-0710KL | I-071 | Chip Resistor |
| R15, R21 | | | | | |
| R4 | 1.5M | 1.5M 5% 0402 | ERJ-2GEJ155X | I-149 | Chip Resistor |
| R5 | 39K | 39K 5% 0402 | RC0402JR-0739KL | I-149 | Chip Resistor |
| R9 | 1.00K | 1.00K 1% 0402 | CRCW0402-1001FRT7 DALE | I-049 | Chip Resistor |
| R31, R33 | 300 | 300 5% 0603 | 300 5% 0603 | | Chip Resistor |
| R32 | 68K | 67K 5% 0603 | 68K 5% 0603 | | Chip Resistor |
| S1 | Reed Switch | 300 mA 60 V 1 W | KSK-1A04-1015 | | Reed Switch |
| U1 | PIC12F615 | 8-bit MCU | PIC12F615-I/MD | | Microcontroller |
| U2′ | ZXLD1615 | Adj. to 28 V 0.25 A | ZXLD1615ET5TA | J-087 | Voltage Booster |
| U3 | MCP73831T-2ACI/OT | MCP73831T-2ACI/OTDKR- | MCP73831T-2ACI/OT | | Li-Ion Charger |
| | | ND | | | |
| U4 | Si1869 FDC6324L | Si1869 FDC6324L | Si1869 FDC6324L | | Load Switch |

In further accordance with the disclosed embodiments, components of the printed circuit board 150 can be coated with one or more moisture resistant layer(s) to prevent shorting and/or corrosion of the circuit components.

In further accordance with the disclosure, the power source 160 can include a power storage device, such as a capacitor or battery, or other suitable source of power. The power source 160 can be located proximate a bottom of the compartment. A conductive lead 162 can be included that extends from a lower face of the battery 160 around to an upper face of the battery 160. The conductive lead 162 can include a contact pad on an upper surface thereof for contacting the printed circuit board 150. If desired, the printed circuit board 150 can be disposed in the compartment 130 above the battery 160. Moreover, the acoustical piezoelectric transducer 140 can be disposed above the printed circuit board 150 in the compartment 130 to help define an acoustical chamber above the transducer 140 and below the inner wall 124 of the upper portion 120. The acoustical transducer 140 can achieve electrical communication with the printed circuit board 150 by direct physical electrical contact with the board 150 upon assembly of the device, or by way of one or more conductive leads or circuits connecting the acoustical transducer 140 to the printed circuit board 150.

As discussed above, in some implementations, the base portion 110 can define a plurality of openings 118a-c therethrough, such as proximate the lower face of the battery 160 when the device 100 is assembled. At least one of the openings 118a-c can be near the conductive lead 162, and a second opening can be near an exposed portion of the lower face of the battery 160. The plurality of openings 118a-c are preferably configured removably receive leads of an electrical charger 220, such as a USB connector, discussed in further detail below. It will similarly be appreciated that conductors for charging the battery can extend proximate an outer surface of the base portion 110, particularly where the base portion is made from dielectric material. The openings 118a-c can also act to vent back pressure from the acoustical transducer 140. The base portion no and upper portion 120 is preferably composed principally of an electrically insulating material, such as polymeric materials, composite materials, and the like. In some implementations, the base portion 110 and upper portion 120 can be composed principally of a glass filled polymeric material.

As alluded to above, the microcontroller 153 can be configured to activate a voltage converter 156 mounted on the printed circuit board 150 when the microcontroller 153 is actuated by way of the reed switch 154 being actuated by the magnet 200. The microcontroller 153 can further be configured to not actuate the acoustical transducer 140 for a predetermined period of time after the microcontroller 153 is actuated. In accordance with further aspects, as discussed in further detail below, the microcontroller 153 can be configured to enter a self-test mode after the microcontroller 153 has been actuated for a first predetermined amount of time. Additionally or alternatively, the microcontroller 153 can be configured to actuate the acoustical transducer 140 after the microcontroller has been actuated for a second predetermined amount of time. For example, the microcontroller 153 can be configured to actuate the acoustical transducer 140 for a full alarm cycle after the microcontroller 153 has been actuated for a predetermined amount of time. In one embodiment, the device 100 can have a plurality (e.g., three) modes of operation. Modes for operation include self-test, alarm, and recharging. Aspects of each of the modes for operation are discussed below.

In an exemplary embodiment, when the upper portion 120 of the device 100 is rotated with respect to the base portion 110, (for example, when the upper portion 120 is rotated sixty (60) degrees counterclockwise), magnet 200 comes within the vicinity of the reed switch 154. The reed switch 154 then closes, triggering the microcontroller 153 and turning on the voltage convertor 156, which enables the power to the rest of the circuit.

The microcontroller 153 may be programmed with a variety of logic paths. Generally, actions taken by the microcontroller 153 are time dependent. In exemplary embodiments, the microcontroller 153 times the switch closure. If the switch closure is less than 0.5 seconds (ring is rotated clockwise to the off position), nothing happens. If the switch closure is between 0.5 and 1.0 seconds (after which, the ring is rotated to the off position), then the self-test mode is initiated. If the switch closure is greater than 1.5 seconds then the alarm mode (see following section) is activated. In another embodiment, turning the ring on will cause it to enter test mode automatically, and then into alarm mode after a predetermined period of time (e.g., 0.5, 1.0 or 1.5 seconds).

For example, in one implementation, the device can be turned on (e.g., by rotating the upper portion) and the device can pause for a predetermined period of time (e.g., 0.5 seconds), and then provide a device status, such as battery status by flashing a colored light, or beeping. For example, one acoustical emission, or “beep” can indicate a low battery level condition, while two beeps can indicate a good battery level. After the battery level indication step, the device can then pause for a second predetermined period of time (e.g., 0.5 seconds), and thereafter trigger the alarm. If desired, when activated, the device can be configured to not shut the alarm off until the battery runs out.

As seen in FIGS. 10-11C, the alarm module device can also be attached or attachable to a sport band (e.g., silicone or elastomeric wrist or ankle band), and the like. Preferably, the band is made of neoprene material, elastomeric or other flexible material (e.g., silicone, etc.), and can be provided with a geometric pattern or texture for aesthetic appearance. By providing a band of flexible material, the article can be slipped onto the wearer, i.e., on the wearer's wrist, without the requirement for mechanical locking means, metal castings, stampings, or the like. Preferably, the width of the article is small, and preferably no more than 30 millimeters wide. It will be appreciated though that the device can be made of metal, plastic, and the like, if preferred. It will be further appreciated that the device can be provided with a low profile visual display (not depicted) that can display the time and or date, device functions, or the like. While not depicted, the device can be provided with additional circuitry and the like to support these additional functions.

While the embodiment described above incorporates a magnetically activated switch mounted thereon or in electrical communication with the printed circuit board for delivering electrical power from the power source to the circuitry, this alternative embodiment preferably includes a pressure switch which can be activated by way of a button which can be pressed down to activate the alarm module.

This embodiment preferably includes a housing defining a compartment therein, like that in the first embodiment described above, which contains the printed circuit board disposed in the compartment including circuitry for actuating at least one electrically driven accessory (such as an electrical transducer), a rechargeable power source in selective electrical communication with the at least one electrically driven accessory by way of the printed circuit board, and an electrical charging port being in electrical communication with the rechargeable power source and being configured to removably receive an electrical charger. The circuitry within the housing is preferably similar to that of the first embodiment, but comprises actuation which can be initiated by one or more buttons, preferably on the side of the band, triggered by squeezing the same. Preferably, the only changes to the circuit in this embodiment relate to the charging circuit (preferably built into the module), which preferably incorporate a polarized magnetic connector to ensure automatic correct connection of the power input, and possibly a higher output voltage, more efficient voltage step up circuit.

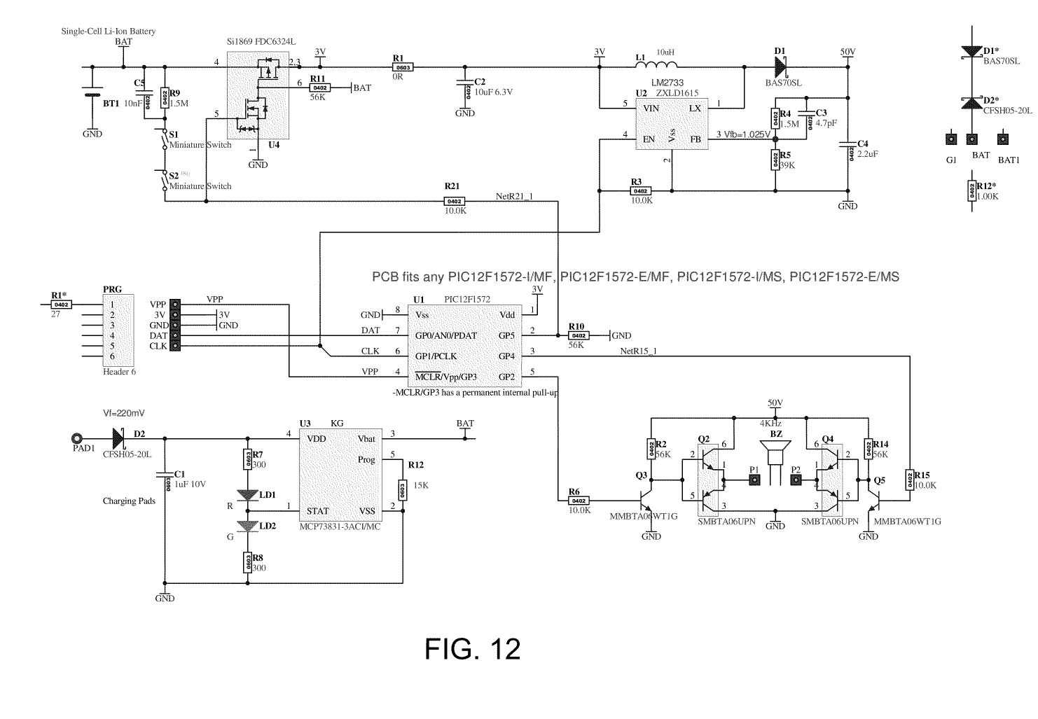

The housing is preferably neoprene, embedded in a wristband or other similar article. The housing preferably has one or more apertures 1002 therein, configured to receive leads of a removable electrical charger. The internal components will preferably be layered identically to the first embodiment, seen in FIG. 1. Table 3 below summarizes the identity and relevant parameters for each component, which can be seen in schematic form in FIG. 12:

TABLE 3

| Designator | Comment | Value | Manufacturer PN | Location | Description |
|---|---|---|---|---|---|
| BT1 | LIR2032 | 3.7 V LIR | LIR2032 | | Single-cell |
| | | | | | Li-Ion Battery |
| BZ | AB2040B | BUZZER | AB2040B | | Loudspeaker |
| | | ELEMENT PIEZO | | | |
| | | 4 KHz 20 mm | | | |
| C1 | C0603C105Z8V | C0603C105Z8V | C0603C105Z8V | | Ceramic Chip |
| | | | | | Capacitor |
| C2 | GMC10X5R106M6R3NT | 10 uF 6.3 V 0603 | GMC10X5R106M6R3NT | | Ceramic Chip |
| | | | | | Capacitor |
| C3 | CL05C4R7CB5NNNC | 4.7 pF 50 V 0402 | CL05C4R7CB5NNNC | | Ceramic Chip |
| | | | | | Capacitor |
| C4 | C2012Y5V1H225Z | 2.2 uF 50 V 0805 | C2012Y5V1H225Z | | Ceramic Chip |
| | | | | | Capacitor |
| C5 | (C0402C103J3RACTU) | 0.01 uF 25 V X7R | (C0402C103J3RACTU) | | Ceramic Chip |
| | | 0402 | | | Capacitor |
| D1, D1* | BAS70SL | BAS70SL | BAS70SL | | Schottky Diode |
| D2 | CDBU0245 | CFSH05-20L | CDBU0245 | | Schottky Diode |
| D2* | CFSH05-20L | CFSH05-20L | CFSH05-20L | | Schottky Diode |
| L1 | Vishay | 10 uH 620 mA 0806 | Vishay | | Inductor |
| | (IFSC0806AZER100M01) | | (IFSC0806AZER100M01) | | |
| LD1 | LTST-C193KRKT-5A | RED 0603 | LTST-C193KRKT-5A | J-158 | RED SMT LED |
| LD2 | LTST-C193KGKT-5A | Green 0603 | LTST-C193KGKT-5A | J-121 | Green SMT LED |
| Q2, Q4 | SMBTA06UPN | SMBTA06UPN | SMBTA06UPN | | NPN/PNP |
| Q3, Q5 | MMBTA06WT1G | NPN 80 V 100 mA | MMBTA06WT1G | | NPN Bipolar |
| | | | | | Transistor |
| R1 | 0R 5% 0603 | 0R 5% 0603 | 0R 5% 0603 | | Chip Resistor |
| R2, R10, R11, | RC0402JR-0756KL | 56K 1% 0402 | RC0402JR-0756KL | | Chip Resistor |
| R14 | | | | | |
| R3, R6, R15, | RC0402FR-0710KL | 10.0K 1% 0402 | RC0402FR-0710KL | I-071 | Chip Resistor |
| R21 | | | | | |
| R4, R9 | ERJ-2GEJ155X | 1.5M 5% 0402 | ERJ-2GEJ155X | I-149 | Chip Resistor |
| R5 | RC0402JR-0739KL | 39K 5% 0402 | RC0402JR-0739KL | I-149 | Chip Resistor |
| R7, R8 | 300 5% 0603 | 300 5% 0603 | 300 5% 0603 | | Chip Resistor |
| R12 | PAN (ERJ-3EKF1502) | 15K 1% 0603 | PAN (ERJ-3EKF1502) | | Chip Resistor |
| R12* | CRCW0402-1001FRT7 DALE | 1.00K 1% 0402 | CRCW0402-1001FRT7 DALE | I-049 | Chip Resistor |
| S1, S2 | 901AGQF | SPST-NO R/A | 901AGQF | | Miniature Switch |
| | | 50 mA@12 V | | | |
| U1 | PIC12F1572-I/MS | 8-bit MCU | PIC12F1572-I/MS | | Microcontroller |
| | PIC12F1572-E/MS | | PIC12F1572-E/MS | | |
| U2 | ZXLD1615ET5TA | Adj. to 28 V 0.25 A | ZXLD1615ET5TA | J-087 | Voltage Booster |
| U3 | MCP73831-3ACI/MC | MCP73831T- | MCP73831-3ACI/MC | | Li-Ion Charger |
| | | 2ACI/OTDKR-ND | | | |
| U4 | Si1869 FDC6324L | Si1869 FDC6324L | Si1869 FDC6324L | | Load Switch |

Self-Test Mode:

If the microcontroller 153 enters a self-test mode, then various aspects of the circuitry may be cycled. For example, when the self-test mode is initiated, the microcontroller 153 will turn on and stay on for the self-test cycle even when the reed switch is off (ring turned back to clockwise stop). A MOSFET is turned on for the functional duration, bypassing reed switch and enabling power on. The voltage convertor 156 will receive power from the battery 160 and be enabled by an output from the microcontroller 153. The voltage converter 156 will then convert battery voltage up to a given voltage, such as 50 V. Power is directed to the transistor pair 158 used as an amplifier, which will amplify the signal. For example, the transistor pair 158 may amplify an initial signal on the order of 3-4 V to upwards of 70 V peak to peak. The microcontroller 153 will measure the voltage of the power source 160. At this point, the device can issue one or two beeps, for example, as described above, to indicate whether or not the battery level is adequate. If the voltage is sufficient for proper operation, a healthy power signal is generated and fed to the amplifier 158. If the voltage is insufficient for proper operation, a low-power signal is generated and fed to the amplifier 158. The transistor pair 158 amplifies output of the microcontroller 153 and feeds a signal to the piezoelectric transducer 140. Subsequently, the microcontroller 153 will finish the self-test function and return to a low-power state, shutting off the MOSFET which in turn will shut down the entire system.

Alarm Mode:

In the exemplary embodiment, the alarm mode is triggered after the upper portion 120 has been rotated counterclockwise into an on position for more than 1.5 seconds. In some embodiments, the alert will turn on and stay on for a given duration even when the reed switch is off (ring turned back to clockwise stop). When the alarm mode is activated, the MOSFET is turned on for the functional duration, bypassing reed switch 154 and enabling power on the voltage convertor 156. The MOSFET is enabled by an output from the microcontroller 153 and will convert incoming voltage up to about 50 V. Power is then directed to the transistor pair 158 (amplifier) for amplification. The microcontroller 153 will enter alarm mode and output the alarm signal to the piezoelectric transducer 140 which will produce an audible alarm. Once the microcontroller 153 is finished executing the alarm function, the microcontroller 153 will return to a low-power state, shutting off the MOSFET which in turn will shut down the entire system.

Recharge Mode:

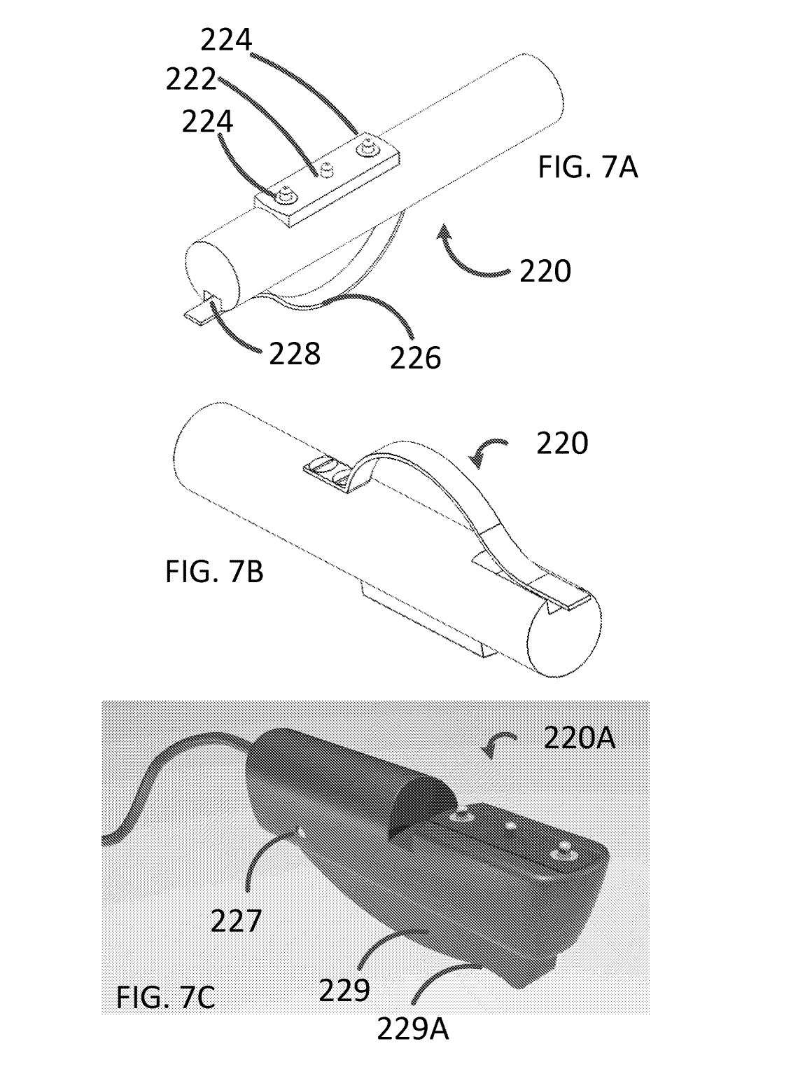

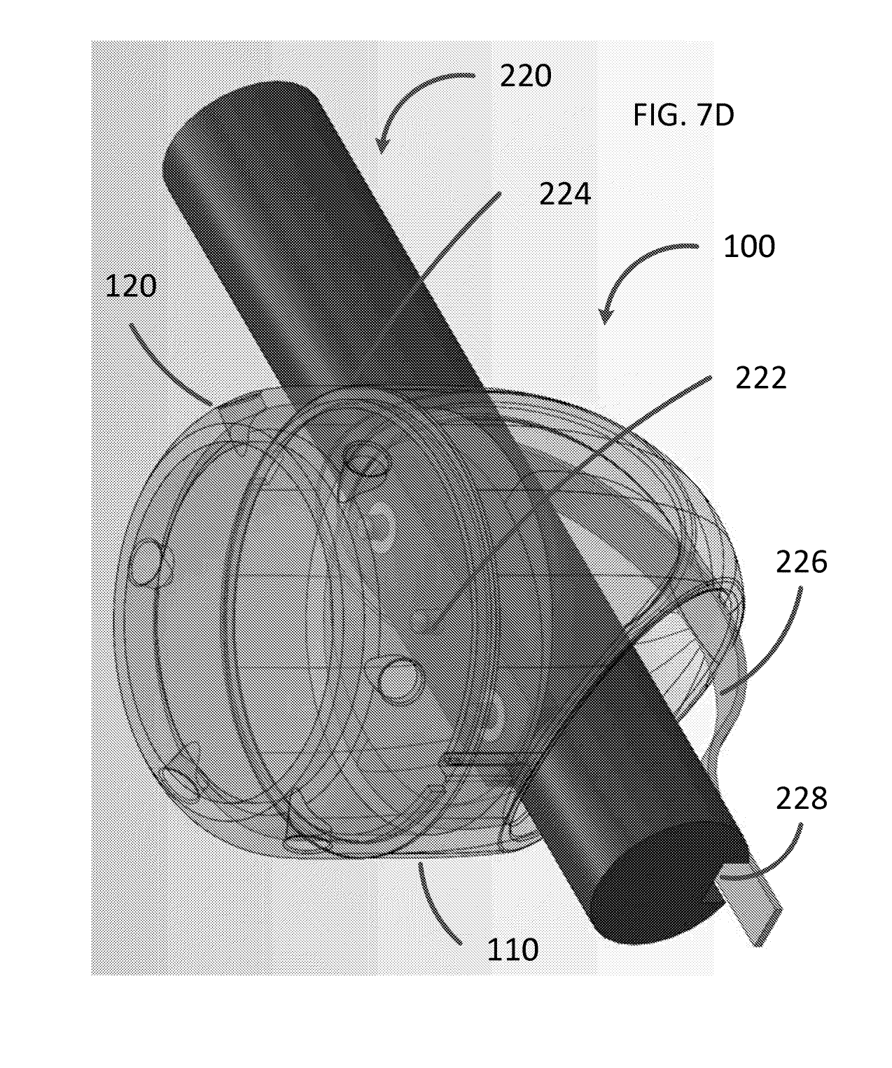

In an exemplary embodiment, a charger 220 is plugged into the device 100. Referring to FIGS. 7A-C, aspects of an exemplary charger 220 are shown. Generally, the charger 220 includes a guide 222 in the form of a boss which cooperates and aligns with the central opening or recess 118b on the base portion 110. Generally, guide 222 is somewhat larger than charging contacts 224 and serves to align the charging contacts 224 with respective ring apertures 118a, c. In the embodiment shown, the charger 60 includes an elongate cylindrical body that resembles the geometry of a finger that may be inserted into the band that defines the lower segment of the base portion 112. An alignment spring 226 is provided attached to the charger 220 at a first end, and permitted to slid into an alignment groove 228 at a second end. The outward bow of the spring urges against the band of the base portion 110, forcing guide 222 and contacts 224 into coupled alignment with the underside of the base portion as illustrated in FIG. 7D. In the embodiment shown in FIGS. 7A-7B, the spring 226 is a leaf spring. However, other types of springs or spreading mechanisms may be used. For example, FIG. 7C illustrates an embodiment of a charger 220A including a spring loaded arm 229 for biasing the charging contacts against the underside of the ring, wherein a concavity 229A is defined on the arm for engaging with the bottom of the ring. As illustrated, the arm 229 is configured to pivot about a pin 227 including an interior spring of the leaf or coil type, for example. The arm 229 of the charger 220A FIG. 7C can alternatively be molded as a natural hinge integral with the body of the charger, as desired. The body of charger 220 includes an internal electrical path to an external connection such as an external power supply provided by, for example, a universal-serial-bus (USB) device. While an acoustical transducer 140 is illustrated, in other embodiments, the device 100 can additionally or alternatively include other electrically driven accessory(ies) such as a lighting device, a capacitor driven visible flash, and the like. In further embodiments, the device 100 can include a wireless charging antenna for charging the onboard power source 160 (e.g., capacitor or battery).

The external power supply may be configured with appropriate visual indicators such as different colored LEDs to indicate a state of the charging. For example, once the charger 220 is connected to the device 100, indication of an appropriate charging voltage current applied to battery may be provided by a red or other colored light. Once the battery within the device starts to charge, a different color light (e.g., amber light) may be indicated, or the red colored light can simply stay on. Completion of a charging cycle may be indicated with a light of a third color (e.g., green), if desired.

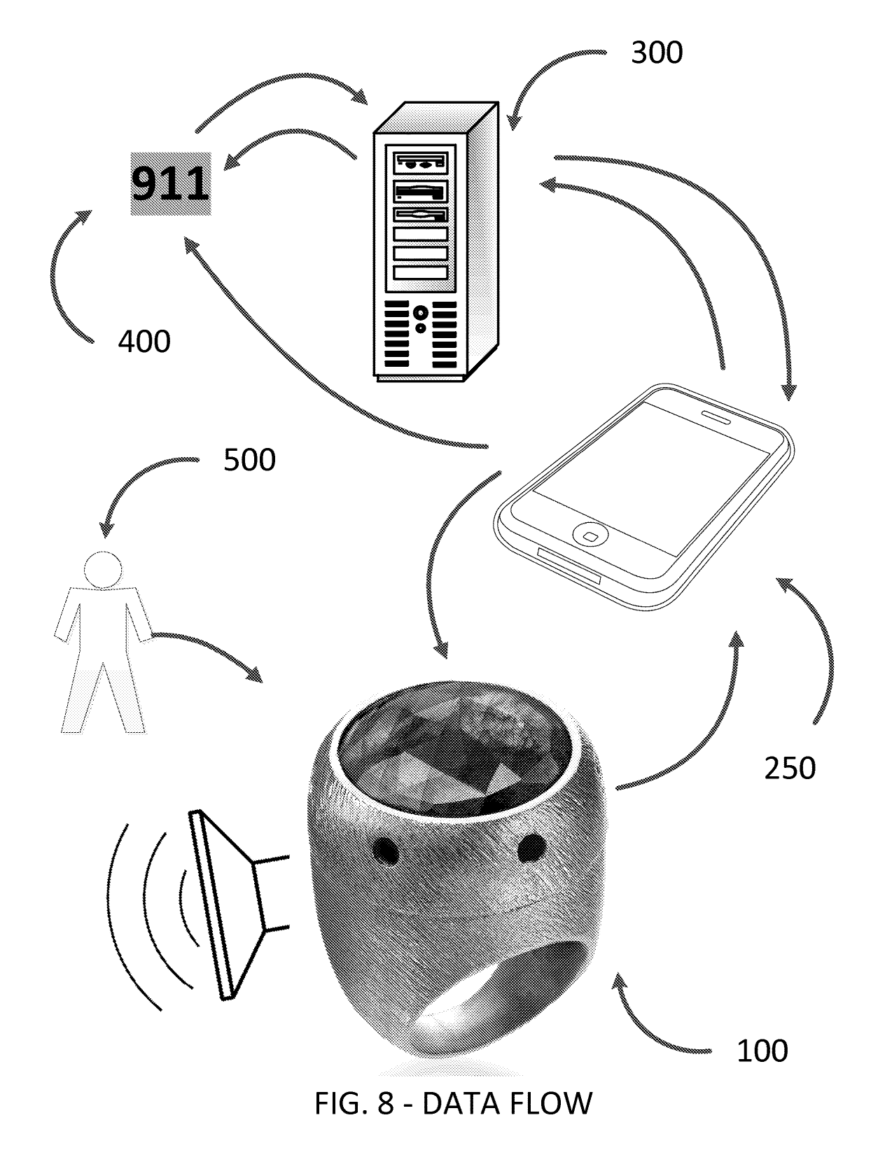

In accordance with a further embodiment and as illustrated in FIG. 8, the microcontroller 153 can be further configured to communicate wirelessly with a mobile communications device 250 during the alarm cycle and/or at other times. The mobile communications device 250 can be a smart phone, tablet, communication system (such as relating to emergency services), and the like. The smart phone or tablet 250 can be provided with a software application (“app”) that can be used to modify settings on the wearable device 100 and/or to diagnose the wearable device 100. For example, the app can be provided with graphical user interfaces and soft controls for monitoring aspects of the wearable device 100, such as the amount of power stored in the power source 160 of the device to track progress of recharging the device too via the charger 220 or monitoring power levels of the device 100 or any other electrically-related parameter described herein during usage, and for displaying results of a diagnostic test. The wearable device too and smart phone or tablet 250 can each be provided, if desired, with a near field communication (“NFC”) tag to permit delivery of information of the mobile device 250 (smart phone, tablet) to the wearable device when the device is turned off, wherein the wearable device can query the NFC tag after it is activated and read the information on the NFC tag. Similarly, the wearable device too can deliver the results of the last self test or other parameters (e.g., last known battery level) to the NFC tag so that it can be read by the mobile device 250. Thus, the device too could effectively be diagnosed using the app, even when it is turned off, and even if the battery 160 is drained.

In some implementations, the mobile communications device 250 can be configured to permit a user 500 (e.g., a wearer of device too) to contact an emergency service 400 directly, or via a computer network 300, after receiving a signal from the alarm module through the app or a different software program. The device 100 can be further configured to access the GPS feature of the mobile device 250 (if provided) to determine its GPS coordinates, and transmit the coordinates with the alert message. For example, the mobile communications device 250 can be configured to transmit geolocation coordinates to an emergency service after receiving a signal from the wearable device. The microcontroller 253 can be configured to communicate wirelessly with the mobile communications device using a Bluetooth communications protocol, for example, via suitable hardware provided within device too.

### Example

### SIREN™ Controller

FIG. 9 illustrates inventive aspects of a SIREN™ controller 601 for controlling a system such as that illustrated in FIG. 8 implementing some of the embodiments disclosed herein. In this embodiment, the SIREN™ controller 601 may serve to aggregate, process, store, search, serve, identify, instruct, generate, match, and/or facilitate interactions with a computer through various technologies, and/or other related data.

Typically, a user or users, e.g., 633a, which may be people or groups of users and/or other systems, may engage information technology systems (e.g., computers) to facilitate operation of the system and information processing. In turn, computers employ processors to process information; such processors 603 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 629 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the SIREN™ controller 601 may be connected to and/or communicate with entities such as, but not limited to: one or more users from user input devices 611; peripheral devices 612, device too; an optional cryptographic processor device 628; and/or a communications network 613. For example, the SIREN™ controller 601 may be connected to and/or communicate with users, e.g., 633a, operating client device(s), e.g., 633b, including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s) and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The SIREN™ controller 601 may be based on computer systems that may comprise, but are not limited to, components such as: a computer systemization 602 connected to memory 629.

Computer Systemization

A computer systemization 602 may comprise a clock 630, central processing unit (“CPU(s)” and/or “processor(s)” (these terms are used interchangeable throughout the disclosure unless noted to the contrary)) 603, a memory 629 (e.g., a read only memory (ROM) 606, a random access memory (RAM) 605, etc.), and/or an interface bus 607, and most frequently, although not necessarily, are all interconnected and/or communicating through a system bus 604 on one or more (mother)board(s) 602 having conductive and/or otherwise transportive circuit pathways through which instructions (e.g., binary encoded signals) may travel to effect communications, operations, storage, etc. Optionally, the computer systemization may be connected to an internal power source 686; e.g., optionally the power source may be internal. Optionally, a cryptographic processor 626 and/or transceivers (e.g., ICs) 674 may be connected to the system bus. In another embodiment, the cryptographic processor and/or transceivers may be connected as either internal and/or external peripheral devices 612 via the interface bus I/O. In turn, the transceivers may be connected to antenna(s) 675, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing SIREN™ controller to determine its location)); Broadcom BCM4329 FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 629 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the SIREN™ controller and beyond through various interfaces. Should processing requirements dictate a greater amount speed and/or capacity, distributed processors (e.g., Distributed SIREN™ embodiments), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the SIREN™ implementations may be achieved by implementing a microcontroller such as CAST's R8051XC2 microcontroller; Intel's MCS 51 (i.e., 8051 microcontroller); and/or the like. Also, to implement certain features of the SIREN™ embodiments, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the SIREN™ component collection (distributed or otherwise) and/or features may be implemented via the microprocessor and/or via embedded components; e.g., via ASIC, coprocessor, DSP, FPGA, and/or the like. Alternately, some implementations of the SIREN™ may be implemented with embedded components that are configured and used to achieve a variety of features or signal processing.

Depending on the particular implementation, the embedded components may include software solutions, hardware solutions, and/or some combination of both hardware/software solutions. For example, SIREN™ features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the SIREN™ features. A hierarchy of programmable interconnects allow logic blocks to be interconnected as needed by the SIREN™ system designer/administrator, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the SIREN™ may be developed on regular FPGAs and then migrated into a fixed version that more resembles ASIC implementations. Alternate or coordinating implementations may migrate SIREN™ controller features to a final ASIC instead of or in addition to FPGAs. Depending on the implementation all of the aforementioned embedded components and microprocessors may be considered the “CPU” and/or “processor” for the SIREN™

Power Source

The power source 686 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 686 is connected to at least one of the interconnected subsequent components of the SIREN™ thereby providing an electric current to all subsequent components. In one example, the power source 686 is connected to the system bus component 604. In an alternative embodiment, an outside power source 686 is provided through a connection across the I/O 608 interface. For example, a USB and/or IEEE 1394 connection carries both data and power across the connection and is therefore a suitable source of power.

Interface Adapters

Interface bus(ses) 607 may accept, connect, and/or communicate to a number of interface adapters, conventionally although not necessarily in the form of adapter cards, such as but not limited to: input output interfaces (I/O) 608, storage interfaces 609, network interfaces 610, and/or the like. Optionally, cryptographic processor interfaces 627 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 609 may accept, communicate, and/or connect to a number of storage devices such as, but not limited to: storage devices 614, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 610 may accept, communicate, and/or connect to a communications network 613. Through a communications network 613, the SIREN™ controller is accessible through remote clients 633b (e.g., computers with web browsers) by users 633a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed SIREN™), architectures may similarly be employed to pool, load balance, and/or otherwise increase the communicative bandwidth required by the SIREN™ controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 610 may be used to engage with various communications network types 613. For example, multiple network interfaces may be employed to allow for the communication over broadcast, multicast, and/or unicast networks.

Input Output interfaces (I/O) 608 may accept, communicate, and/or connect to user input devices 611, peripheral devices 612, cryptographic processor devices 628, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 611 often are a type of peripheral device 612 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 612, such as mobile device 250 and device 100 and the like may be connected and/or communicate to I/O and/or other facilities of the like such as network interfaces, storage interfaces, directly to the interface bus, system bus, the CPU, and/or the like. Peripheral devices may be external, internal and/or part of the SIREN™ controller.

Cryptographic units such as, but not limited to, microcontrollers, processors 626, interfaces 627, and/or devices 628 may be attached, and/or communicate with the SIREN™ controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

Memory

Generally, any mechanization and/or embodiment allowing a processor to affect the storage and/or retrieval of information is regarded as memory 629 (or 68, 72, etc.). However, memory is a fungible technology and resource, thus, any number of memory embodiments may be employed in lieu of or in concert with one another. It is to be understood that the SIREN™ controller and/or a computer systemization may employ various forms of memory 629. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 629 will include ROM 606, RAM 605, and a storage device 614. A storage device 614 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

Component Collection

The memory 629 may contain a collection of program and/or database components and/or data such as, but not limited to: operating system component(s) 615 (operating system); information server component(s) 616 (information server); user interface component(s) 617 (user interface); Web browser component(s) 618 (Web browser); database(s) 619; mail server component(s) 621; mail client component(s) 622; cryptographic server component(s) 620 (cryptographic server) and/or the like (i.e., collectively a component collection). These components may be stored and accessed from the storage devices and/or from storage devices accessible through an interface bus. Although non-conventional program components such as those in the component collection, typically, are stored in a local storage device 614, they may also be loaded and/or stored in memory such as: peripheral devices, RAM, remote storage facilities through a communications network, ROM, various forms of memory, and/or the like.

Operating System

The operating system component 615 is an executable program component facilitating the operation of the SIREN™ controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Nan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the SIREN™ controller to communicate with other entities through a communications network 613. Various communication protocols may be used by the SIREN™ controller as a subcarrier transport mechanism for interaction, such as, but not limited to: multicast, TCP/IP, UDP, unicast, and/or the like.

Information Server

An information server component 616 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the SIREN™ controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the SIREN™ database 619, operating systems, other program components, user interfaces, Web browsers, and/or the like.

Access to the SIREN™ database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the SIREN™ In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the SIREN™ as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 617 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component 618 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the SIREN™ enabled nodes. The combined application may be nugatory on systems employing standard Web browsers.

Mail Server

A mail server component 621 is a stored program component that is executed by a CPU 603. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the SIREN™.

Access to the SIREN™ mail may be achieved through a number of APIs offered by the individual Web server components and/or the operating system.

Also, a mail server may contain, communicate, generate, obtain, and/or provide program component, system, user, and/or data communications, requests, information, and/or responses.

Mail Client

A mail client component 622 is a stored program component that is executed by a CPU 603. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component 620 is a stored program component that is executed by a CPU 603, cryptographic processor 626, cryptographic processor interface 627, cryptographic processor device 628, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the SIREN™ may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the SIREN™ component to engage in secure transactions if so desired. The cryptographic component facilitates the secure accessing of resources on the SIREN™ and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

The SIREN™ Database

The SIREN™ database component 619 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the SIREN™ database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the SIREN™ database is implemented as a data-structure, the use of the SIREN™ database 619 may be integrated into another component such as the SIREN™ component 635. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 619 includes several tables 619a-n. A Users (e.g., operators) table 619a may include fields such as, but not limited to: user_id, ssn, dob, first_name, last_name, age, state, address_firstline, address_secondline, zipcode, devices_list, contact_info, contact_type, alt contact_info, alt contact_type, and/or the like to refer to any type of enterable data or selections discussed herein. The Users table may support and/or track multiple entity accounts. A Clients table 619b may include fields such as, but not limited to: user_id, client_id, client_ip, client_type, client_model, operating_system, os_version, app_installed_flag, and/or the like. An Apps table 619c may include fields such as, but not limited to: app_ID, app_name, app_type, OS_compatibilities_list, version, timestamp, developer_ID, and/or the like. A performance table 619d including, for example, performance data of the wearable device 100 can be provided listing useful parameters of the device 100, such as voltage_level, power_drain_time, and/or the like. An Parameter table 619e may include fields including the foregoing fields, or additional ones such as self_test_start_time, self_test_duration, alarm_cycle_time, and/or the like. A routines table 619f may include a plurality of performance sequences including fields such as, but not limited to: sequence_type, sequence_id, battery_drain_rate, avg_battery_voltage, applied_voltage_to_transducer, and/or the like.

In one embodiment, user programs may contain various user interface primitives, which may serve to update the SIREN™ platform. Also, various accounts may require custom database tables depending upon the environments and the types of clients the SIREN™ system may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 619a-n. The SIREN™ system may be configured to keep track of various settings, inputs, and parameters via database controllers.

The SIREN™ database may communicate to and/or with other components in a component collection, including itself, and/or facilities of the like. Most frequently, the SIREN™ database communicates with the SIREN™ component, other program components, and/or the like. The database may contain, retain, and provide information regarding other nodes and data.

The SIREN™ Components

The SIREN™ component 635 is a stored program component that is executed by a CPU. In one embodiment, the SIREN™ component incorporates any and/or all combinations of the aspects of the SIREN™ systems discussed in the previous figures. As such, the SIREN™ component affects accessing, obtaining and the provision of information, services, transactions, and/or the like across various communications networks.

The SIREN™ component may transform data collected by the device 100 or input signals received, e.g., from a mobile device 250, into commands for operating the device 100.

The SIREN™ component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the SIREN™ server employs a cryptographic server to encrypt and decrypt communications. The SIREN™ component may communicate to and/or with other components in a component collection, including itself, and/or facilities of the like. Most frequently, the SIREN™ component communicates with the SIREN™ database, operating systems, other program components, and/or the like. The SIREN™ may contain, communicate, generate, obtain, and/or provide program component, system, user, and/or data communications, requests, and/or responses.

Distributed SIREN™ Embodiments

The structure and/or operation of any of the SIREN™ node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the SIREN™ controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c -post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the SIREN™ controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(‘Content-Type: text/plain’);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, o);
socket_bind($sock, $address, $port) or die(‘Could not bind to address’);
socket_listen($sock);
$client = socket_accept($sock);
// read input data from client device in 1024 byte blocks until end of
message
do {
    $input = “”;
    $input = socket_read($client, 1024);
    $data .= $input;
} while($input != “”);
// parse data to extract variables
$obj = json_decode($data, true);
// store input data in a database
mysql_connect(″201.408.185.132″,$DBserver,$password); // access
database server
mysql_select(″CLIENT_DB.SQL″); // select database to append
mysql_query(“INSERT INTO UserTable (transmission)
VALUES ($data)”); // add data to UserTable table in a CLIENT database
mysql_close(″CLIENT_DB.SQL″); // close connection to database
?>
```

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/
index.jsp?topic=/com.ibm.IBMDI.doc/referenceguide295.htm

and other parser implementations:

http://publib.boulder.ibm.com/infocenter/tivihelp/v2r1/
index.jsp?topic=/com.ibm.IBMDI.doc/referenceguide259.htm

all of which are hereby expressly incorporated by reference.

In order to address various issues and advance the art, the entirety of this application (including the Cover Page, Title, Headings, Field, Background, Summary, Brief Description of the Drawings, Detailed Description, Claims, Abstract, Figures, Appendices and/or otherwise) shows by way of illustration various embodiments in which the claimed inventions may be practiced. The advantages and features of the application are of a representative sample of embodiments only, and are not exhaustive and/or exclusive. They are presented only to assist in understanding and teach the claimed principles. It should be understood that they are not representative of all disclosed embodiments. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims. It is to be understood that, depending on the particular needs and/or characteristics of a SIREN™ individual and/or enterprise user, database configuration and/or relational model, data type, data transmission and/or network framework, syntax structure, and/or the like, various embodiments of the SIREN™ may be implemented that enable a great deal of flexibility and customization.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Descriptions herein of circuitry and method steps and computer programs represent conceptual embodiments of illustrative circuitry and software embodying the principles of the disclosed embodiments. Thus the functions of the various elements shown and described herein may be provided through the use of dedicated hardware as well as hardware capable of executing software in association with appropriate software as set forth herein.

In the disclosure hereof any element expressed as a means for performing a specified function is intended to encompass any way of performing that function including, for example, a) a combination of circuit elements and associated hardware which perform that function or b) software in any form, including, therefore, firmware, microcode or the like as set forth herein, combined with appropriate circuitry for executing that software to perform the function. Applicants thus regard any means which can provide those functionalities as equivalent to those shown herein.

Similarly, it will be appreciated that the system and process flows described herein represent various processes which may be substantially represented in computer-readable media and so executed by a computer or processor, whether or not such computer or processor is explicitly shown. Moreover, the various processes can be understood as representing not only processing and/or other functions but, alternatively, as blocks of program code that carry out such processing or functions.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An alarm module, comprising:
a) a base portion;
b) an upper portion covering the base portion, base portion and upper portion cooperating to define a compartment;
c) at least one acoustical transducer;
d) a printed circuit board disposed in the compartment including circuitry for actuating the at least one acoustical transducer; and
e) a power source in selective electrical communication with the at least one acoustical transducer by way of the printed circuit board.

2. The alarm module of claim 1, wherein:
a) the base portion defines a first cavity therein;
b) the upper portion defines a second cavity therein; and
c) the first cavity and second cavity cooperate to define the compartment.

3. The alarm module of claim 1, wherein the acoustical transducer is disposed in the compartment.

4. The alarm module of claim 1, wherein the acoustical transducer is disposed on an exterior portion of the alarm module.

5. The alarm module of claim 1, wherein the upper portion is rotatably displaceable with respect to the base portion.

6. The alarm module of claim 5, wherein the acoustical transducer is actuated by rotating the upper portion with respect to the base portion.

7. The alarm module of claim 1, wherein the alarm module is incorporated into a finger ring.

8. The alarm module of claim 1, wherein the alarm module is incorporated into a time piece.

9. The alarm module of claim 1, wherein the alarm module is incorporated into a wristband.

10. The alarm module of claim 1, wherein the alarm module is incorporated into a pendant.

11. The alarm module of claim 5, wherein the printed circuit board is disposed within an annularly shaped rotor disposed within the compartment, the rotor being connected to the upper portion so that the rotor rotates with the upper portion when the upper portion is rotated.

12. The alarm module of claim 11, wherein the rotor is disposed within a centering ring, wherein the centering ring is arranged with respect to the base portion to prevent the centering ring from rotating with respect to the base portion when the rotor rotates with the upper portion.

13. The alarm module of claim 12, wherein the rotor can be rotatably displaced with respect to the centering ring from a first rotational position to a second rotational position.

14. The alarm module of claim 13, wherein the rotational position of the rotor with respect to the centering ring is maintained in the first rotational position by a first detent.

15. The alarm module of claim 14, wherein the rotational position of the rotor with respect to the centering ring is maintained in the second rotational position by a second detent.

16. The alarm module of claim 15, wherein at least one of the first and second detents includes a circumferential deflection groove formed into the centering ring separating upper and lower ring portions of the centering ring, wherein the detent is energized by compressing the upper and lower ring portions together into the deflection groove.

17. The alarm module of claim 16, wherein the deflection groove passes all the way through the centering ring from a radially outer surface of the centering ring to a radially inner surface of the centering ring.

18. The alarm module of claim 17, wherein at least one of the first and second detents further includes a protrusion formed on at least one of an upper and lower edge of the centering ring.

19. The alarm module of claim 18, wherein the protrusion is formed on at least one of the upper and lower ring portions.

20. The alarm module of claim 19, wherein the protrusion snaps into a recess formed into the rotor when the rotor is in at least one of the first and second rotational positions.

21. The alarm module of claim 12, wherein the centering ring is received in an annular groove formed into an outer radial surface of the rotor.

22. The alarm module of claim 12, wherein the centering ring is a split ring having a first circumferential end near a second circumferential end.

23. The alarm module of claim 22, wherein the first circumferential end and the second circumferential end each abut a protrusion formed on the base portion and extending into the compartment, wherein the protrusion prevents the centering ring from rotating with respect to the base portion when the upper portion is rotated with respect to the base portion.

24. The alarm module of claim 12, wherein the centering ring includes a magnetic portion.

25. The alarm module of claim 12, wherein the magnetic portion includes a permanent magnet.

26. The alarm module of claim 24, wherein the printed circuit board includes a magnetically activated switch for delivering electrical power from the power source to the acoustical transducer.

27. The alarm module of claim 26, wherein the magnetically activated switch is actuated when the magnetic portion of the centering ring is placed in close proximity with the magnetically activated switch.

28. The alarm module of claim 27, wherein the magnetically activated switch is actuated when the rotor is rotatably displaced with respect to the centering ring from the first rotational position to the second rotational position.

29. The alarm module of claim 28, wherein the magnetically activated switch includes a reed switch.

30. The alarm module of claim 1, wherein the power source includes a power storage device.

31. The alarm module of claim 30, wherein the battery is located proximate a bottom of the compartment.

32. The alarm module of claim 31, further comprising a conductive lead extending from a lower face of the battery around to an upper face of the battery.

33. The alarm module of claim 32, wherein the conductive lead includes a contact pad on an upper surface thereof for contacting the printed circuit board.

34. The alarm module of claim 33, wherein the printed circuit board is disposed in the compartment above the battery.

35. The alarm module of claim 34, wherein the acoustical transducer is disposed above the printed circuit board in the compartment.

36. The alarm module of claim 32, wherein the base portion defines a plurality of openings therethrough proximate the lower face of the battery, wherein at least one of the openings is near the conductive lead, and wherein a second opening is near an exposed portion of the lower face of the battery.

37. The alarm module of claim 36, wherein the plurality of openings are configured removably receive leads of an electrical charger.

39. The alarm module of claim 36, wherein the acoustical transducer is in selective electrical communication with the printed circuit board.

40. The alarm module of claim 1, wherein components of the printed circuit board are coated with a moisture resistant layer.

41. The alarm module of claim 1, wherein the base portion defines a port therethrough for venting back pressure from the acoustical transducer.

42. The alarm module of claim 1, wherein the base portion and upper portion are composed principally of an electrically insulating material.

43. The alarm module of claim 42, wherein the base portion and upper portion are composed principally of a glass filled polymeric material.

44. The alarm module of claim 1, wherein the printed circuit board includes a electronic microcontroller.

45. The alarm module of claim 44, wherein the microcontroller is configured to activate a voltage converter mounted on the printed circuit board when the microcontroller is actuated.

46. The alarm module of claim 44, wherein the microcontroller is configured to not actuate the acoustical transducer for a predetermined period of time after the microcontroller is actuated.

46. The alarm module of claim 44, wherein the microcontroller is configured to enter a self-test mode after the microcontroller has been actuated for a predetermined amount of time.

47. The alarm module of claim 44, wherein the microcontroller is configured to actuate the acoustical transducer after the microcontroller has been actuated for a predetermined amount of time.

48. The alarm module of claim 47, wherein the microcontroller is configured to actuate the acoustical transducer for a full alarm cycle after the microcontroller has been actuated for a predetermined amount of time.

49. The alarm module of claim 47, wherein the microcontroller is further configured to communicate wirelessly with a mobile communications device during the alarm cycle.

50. The alarm module of claim 49, wherein the mobile communications device is a smart phone.

51. The alarm module of claim 50, wherein the mobile communications device is configured to contact an emergency service after receiving a signal from the alarm module.

52. The alarm module of claim 51, wherein the mobile communications device is configured to transmit geolocation coordinates to an emergency service after receiving a signal from the alarm module.

53. The alarm module of claim 49, wherein the microcontroller is configured to communicate wirelessly with the mobile communications device using a Bluetooth communications protocol.

54. The alarm module of claim 1, wherein the upper portion defines at least a portion of a resonant chamber, and further wherein the upper portion further defines at least one acoustical passage therethrough to facilitate transmission of acoustical energy generated by the acoustical transducer from inside the resonant chamber to a location outside of the alarm module.

55. The alarm module of claim 1, further comprising a near field communication (“NFC”) tag.

56. An alarm module, comprising:
a) a base portion, including a housing defining a compartment therein;
b) a printed circuit board disposed in the compartment including circuitry for actuating at least one electrically driven accessory;
c) a rechargeable power source in selective electrical communication with the at least one electrically driven accessory by way of the printed circuit board;
d) an upper portion covering the compartment engaged with the base portion; and
e) an electrical charging port defined through at least one of the base portion and the upper portion, the electrical charging port being in electrical communication with the rechargeable power source and being configured to removably receive an electrical charger.

57. The alarm module of claim 56, wherein the electrically driven accessory includes an acoustical transducer mounted on the printed circuit board.
